(19) United States
(12) Patent Application Publication
(10) Pub. No.: US 2026/0332061 A1
(43) Pub. Date: Oct. 22, 2026

(54) INTEGRATED CIRCUIT AND POWER SUPPLY DEVICE

(71) Applicant: FUJI ELECTRIC CO., LTD., Kawasaki-shi (JP)

(72) Inventors: Yukihiro YAGUCHI, Matsumoto-city (JP); Ryoma KAMAKURA, Matsumoto-city (JP)

(73) Assignee: FUJI ELECTRIC CO., LTD., Kawasaki-shi (JP)

(21) Appl. No.: 19/575,666

(22) Filed: Mar. 23, 2026

(30) Foreign Application Priority Data
Apr. 16, 2025 (JP) 2025-067680
Sep. 10, 2025 (JP) 2025-150043

(51) Int. Cl. H02M 7/217; H02M 1/00; H02M 1/088; H02M 1/42; H02M 7/12

(52) U.S. Cl. CPC H02M 7/217; H02M 1/0012; H02M 1/088; H02M 1/4208; H02M 7/125

(57) ABSTRACT

An integrated circuit for a power supply circuit that generates an output voltage at a target level from an alternating current (AC) voltage inputted thereto, the power supply circuit including an inductor configured to receive a voltage corresponding to the AC voltage, and a transistor configured to control an inductor current flowing through the inductor, the integrated circuit being configured to switch the transistor. The integrated circuit includes: a terminal configured to receive a stop signal; a determination circuit configured to determine whether a voltage level of the AC voltage is lower than a predetermined level; a driver circuit configured to switch the transistor, based on the inductor current and the output voltage; and a stop circuit configured to cause the driver circuit to stop switching of the transistor, in response to the voltage level of the AC voltage dropping below the predetermined level after the stop signal is inputted.

### CROSS-REFERENCE TO RELATED APPLICATIONS

The present application claims priority pursuant to 35 U.S.C. §119 from Japanese patent application numbers 2025-067680 and 2025-150043, filed Apr. 16, 2025 and Sep. 10, 2025, respectively, the entire disclosures of which are hereby incorporated by reference herein.

### BACKGROUND

### Technical Field

The present disclosure relates to an integrated circuit and a power supply device.

### Description of the Related Art

The power supply devices include those configured to convert the output from an AC-DC converter using a DC-DC converter, to thereby supply power to a load (for example, Japanese Patent Application Publication Nos. 2024-011611 and 2013-251938).

Meanwhile, in order to improve the efficiency of such a power supply device, the integrated circuit that controls the AC-DC converter and the integrated circuit that controls DC-DC converter may communicate with each other.

However, for example, when an abnormality occurs in the operating conditions of the DC-DC converter, and the like, the operation of the AC-DC converter may not be controlled properly.

### SUMMARY

A first aspect of the present disclosure is an integrated circuit for a power supply circuit that generates an output voltage at a target level from an alternating current (AC) voltage inputted thereto, the power supply circuit including an inductor configured to receive a voltage corresponding to the AC voltage, and a transistor configured to control an inductor current flowing through the inductor, the integrated circuit being configured to switch the transistor, the integrated circuit comprising: a first terminal configured to receive a stop signal; a first determination circuit configured to determine whether a voltage level of the AC voltage is lower than a predetermined level; a driver circuit configured to switch the transistor, based on the inductor current and the output voltage; and a stop circuit configured to cause the driver circuit to stop switching of the transistor, in response to the voltage level of the AC voltage dropping below the predetermined level after the stop signal is inputted.

A second aspect of the present disclosure is a power supply device, comprising: a first power supply circuit that generates a first output voltage at a target level from an alternating current (AC) voltage inputted thereto, the first power supply circuit including an inductor configured to receive a voltage corresponding to the AC voltage, and a first transistor configured to control an inductor current flowing through the inductor; a first integrated circuit configured to switch the first transistor; a second power supply circuit that generates a second output voltage from the first output voltage; and a second integrated circuit used for the second power supply circuit, the second integrated circuit including a load detection circuit configured to detect a condition of a load configured to receive the second output voltage, and a signal output circuit configured to output a stop signal when it is detected that the load has become an overload condition, wherein the first integrated circuit includes: a terminal configured to receive the stop signal, a determination circuit configured to determine whether a voltage level of the AC voltage is lower than a predetermined level, a driver circuit configured to switch the first transistor, based on the inductor current and the first output voltage, and a stop circuit configured to cause the driver circuit to stop switching of the first transistor, in response to the voltage level of the AC voltage dropping below the predetermined level after the stop signal is inputted.

A third aspect of the present disclosure is a power supply device, comprising: a first power supply circuit that generates a first output voltage at a target level from an alternating current (AC) voltage inputted thereto, the first power supply circuit including an inductor configured to receive a voltage corresponding to the AC voltage, and a first transistor configured to control an inductor current flowing through the inductor; a first integrated circuit configured to switch the first transistor; a second power supply circuit that generates a second output voltage from the first output voltage; and a second integrated circuit used for the second power supply circuit, the second integrated circuit including a terminal configure to receive a full-wave rectified voltage obtained by full-wave rectifying the AC voltage, a determination circuit configured to determine whether a voltage level of the AC voltage is lower than a predetermined level, based on the full-wave rectified voltage, a load detection circuit configured to detect a condition of a load configured to receive the second output voltage, and a signal output circuit configured to output a stop signal, in response to the determination circuit determining that the voltage level of the AC voltage drops below the predetermined level after it is detected that the load has become an overload condition, wherein the first integrated circuit includes a terminal thereof configured to receive the stop signal, a driver circuit configured to switch the first transistor, based on the inductor current and the first output voltage, and a stop circuit configured to cause the driver circuit to stop switching of the first transistor, upon receiving the stop signal.

### BRIEF DESCRIPTION OF THE DRAWINGS

FIG. 1 is a diagram illustrating an example of a power supply device 10.

FIG. 2 is a diagram illustrating an example of a DC-DC converter 13.

FIG. 3 is a diagram illustrating an example of a control integrated circuit (IC) 40.

FIG. 4 is a diagram illustrating an example of an AC-DC converter 12.

FIG. 5 is a diagram illustrating an example of a power factor correction IC 75.

FIG. 6A is a diagram illustrating an example of an input line filter 11.

FIG. 6B is a diagram illustrating an example of an input line filter 11 considering a parasitic component.

FIG. 7 is a diagram illustrating an example of an operation of a power factor correction IC 75a.

FIG. 8 is a diagram illustrating an example of a power factor correction IC 75.

FIG. 9 is a diagram illustrating an example of an operation of a power factor correction IC 75b.

FIG. 10 is a diagram illustrating an example of an operation of a power factor correction IC 75b.

FIG. 11 is a diagram illustrating an example of an operation of a power factor correction IC 75b.

FIG. 12 is a diagram illustrating an example of a control IC 40.

FIG. 13 is a diagram illustrating an example of an operation of a control IC 40b.

FIG. 14 is a diagram illustrating an example of an AC-DC converter 12.

FIG. 15 is a diagram illustrating an example of a power factor correction IC 75.

FIG. 16 is a diagram illustrating an example of a DC-DC converter 13.

FIG. 17 is a diagram illustrating an example of a control IC 40.

FIG. 18 is a diagram illustrating an example of an AC-DC converter 12.

FIG. 19 is a diagram illustrating an example of a power factor correction IC 75.

FIG. 20 is a diagram illustrating an example of an AC-DC converter 12.

FIG. 21 is a diagram illustrating an example of a power factor correction IC 75.

FIG. 22 is a diagram illustrating an example of an operation of a power factor correction IC 75b during an instantaneous power failure.

FIG. 23 is a diagram illustrating an example of a power factor correction IC 75.

FIG. 24 is a diagram illustrating an example of an operation of a power factor correction IC 75f.

FIG. 25 is a diagram illustrating an example of a power factor correction IC 75.

### DETAILED DESCRIPTION

At least following matters will become apparent from the descriptions of the present description and the accompanying drawings. The same or equivalent constituent elements, members, and the like illustrated in the drawings are given the same reference numerals, and repetitive description is omitted as appropriate.

### Embodiment of typical power supply device 10

### Overview of power supply device 10

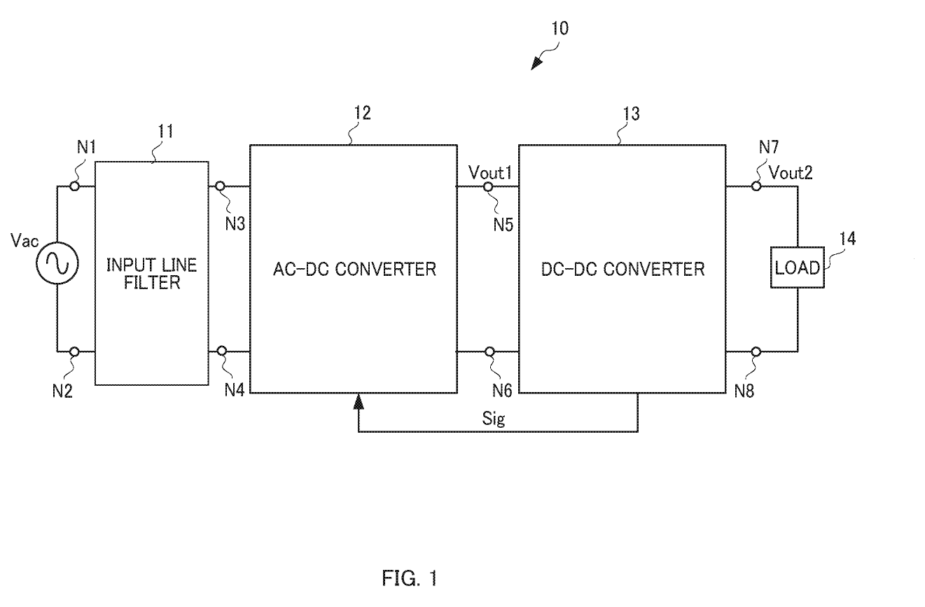

FIG. 1 is a diagram illustrating an example of a power supply device 10. The power supply device 10 includes an input line filter 11, an AC-DC converter 12, and a DC-DC converter 13.

The input line filter 11 is provided so that the noise generated at the AC-DC converter 12 will not be transmitted to the commercial power supply side. The input line filter 11 is provided between nodes N1 and N2 on the commercial power supply side and node N3 and N4 on the AC-DC converter 12 side. Details of the input line filter 11 will be described later.

The AC-DC converter 12 generates an output voltage Vout1 from an alternating-current (AC) voltage Vac applied from the input line filter 11 to the nodes N3, N4. The DC-DC converter 13 generates an output voltage Vout2 from the output voltage Vout1 applied to nodes N5, N6. A load 14 is connected to nodes N7, N8, and the output voltage Vout2 is applied to the load 14. The load 14 is, for example, an electronic device operating on a direct-current (DC) voltage. Further, a setting signal Sig is communicated from the DC-DC converter 13 to the AC-DC converter 12.

### Overview of DC-DC converter 13

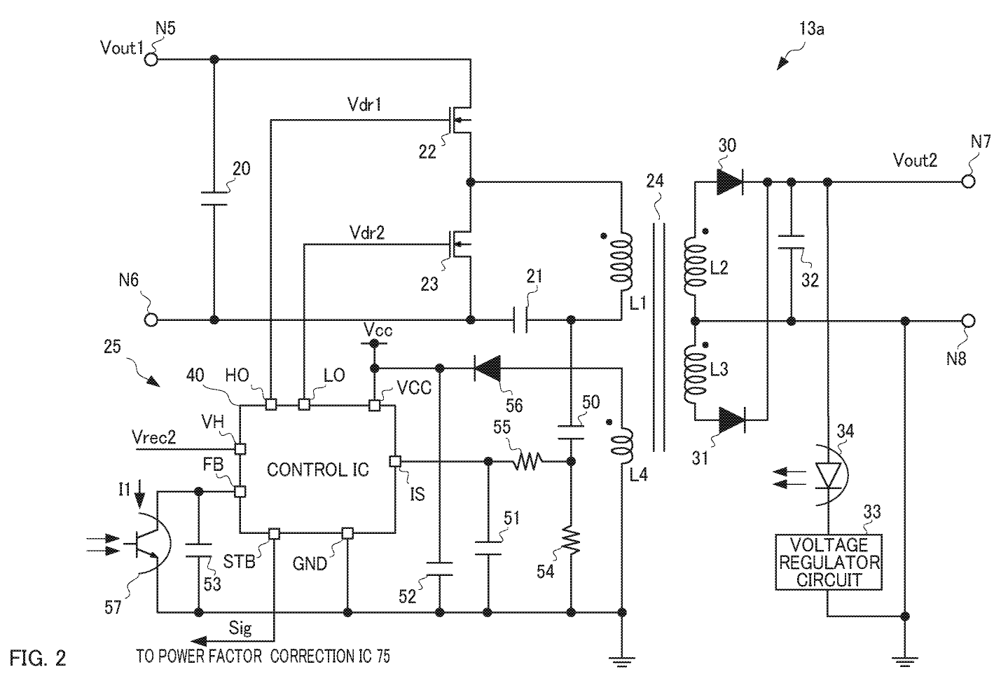

FIG. 2 is a diagram illustrating a configuration of the DC-DC converter 13 included in the power supply device 10 according to an embodiment of the present disclosure. The DC-DC converter 13 is an LLC current-resonant converter that generates, at the load 14, the output voltage Vout2 of a target level from the predetermined input voltage Vout1.

The DC-DC converter 13 includes capacitors 20, 21, 32, N-channel Metal–Oxide–Semiconductor (NMOS) transistors 22, 23, a transformer 24, a control block 25, diodes 30, 31, a voltage regulator circuit 33, and a light-emitting diode 34.

The capacitor 20 stabilizes a voltage between a power supply line which receives the input voltage Vout1 and a ground line on the ground side, to remove noise and the like. Note that the input voltage Vout1 is the DC voltage at a predetermined level.

The NMOS transistor 22 is a high-side power transistor, and the NMOS transistor 23 is a low-side power transistor. Note that the NMOS transistors 22, 23 are used, as switching devices, in an embodiment of the present disclosure, however, for example, P-channel Metal–Oxide–Semiconductor (PMOS) transistors or bipolar transistors may be used instead.

The transformer 24 includes a primary coil L1, secondary coils L2, L3, and an auxiliary coil L4. The primary coil L1, the secondary coils L2, L3, and the auxiliary coil L4 are insulated from one another. In the transformer 24, a voltage is generated at the secondary coils L2, L3 on the secondary side according to a variation in the voltage across the primary coil L1 on the primary side, and a voltage is generated at the auxiliary coil L4 on the primary side according to a variation in the voltage at the secondary coils L2, L3.

Further, the primary coil L1 has one end connected to the source of the NMOS transistor 22 and the drain of the NMOS transistor 23, and the other end connected to the source of the NMOS transistor 23 through the capacitor 21.

Accordingly, in response to the switching of the NMOS transistors 22, 23 being started, the voltage at each of the secondary coils L2, L3 and the auxiliary coil L4 changes. Note that the primary coil L1 and the secondary coils L2, L3 are electromagnetically coupled with the same polarity, and the secondary coils L2, L3 and the auxiliary coil L4 are also electromagnetically coupled with the same polarity.

The control block 25 is a circuit block that controls the switching of the NMOS transistors 22, 23, and will be described in detail later.

The diodes 30, 31 rectify the voltage at the secondary coils L2, L3, and the capacitor 32 smooths the rectified voltage. As a result, the smoothed output voltage Vout2 is generated at the capacitor 32. Note that the output voltage Vout2 results in the DC voltage at the target level.

The voltage regulator circuit 33 generates a constant DC voltage, and is configured using a shunt regulator, for example.

The light-emitting diode 34 emits light having an intensity corresponding to the difference between the output voltage Vout2 and the output of the voltage regulator circuit 33, and configures a photocoupler together with a phototransistor 57 which will be described later. In an embodiment of the present disclosure, with a rise in the level of the output voltage Vout2, the intensity of the light from the light-emitting diode 34 increases.

### Control block 25

The control block 25 includes a control IC 40, capacitors 50 to 53, resistors 54, 55, a diode 56, and the phototransistor 57.

The control IC 40 is an integrated circuit that controls the switching of the NMOS transistors 22, 23, and has terminals VCC, GND, STB, FB, IS, HO, LO, VH.

The terminal VCC is a terminal configured to receive a voltage Vcc to operate the control IC 40. The terminal VCC is connected to a capacitor 52 having one end that is grounded and also connected to the cathode of the diode 56. Thus, the capacitor 52 is charged with the current from the diode 56, and the charge voltage of the capacitor 52 results in the voltage Vcc to operate the control IC 40.

The terminal GND is a terminal configured to receive a ground voltage, and is connected to the housing or the like of an apparatus where the power supply device 10 is provided, for example.

The terminal STB is a terminal configured to output the setting signal Sig to cooperate with a power factor correction IC 75 (described later) that controls the AC-DC converter 12.

The terminal FB is a terminal at which a feedback voltage Vfb_a corresponding to the output voltage Vout2 is generated, and is connected to the capacitor 53 and the phototransistor 57. The capacitor 53 is provided to remove noise between the terminal FB and the ground, and the phototransistor 57 causes a bias current I1 having a magnitude corresponding to the intensity of the light from the light-emitting diode 34 to flow from the terminal FB to the ground. Thus, the phototransistor 57 operates as a transistor that generates a sink current.

The terminal IS is a terminal configured to receive a voltage according to the resonant current of the DC-DC converter 13. Here, at the node at which the capacitor 50 and the resistor 54 are connected, the voltage according to the current value of the resonant current of the primary coil L1 is generated. The resistor 55 and the capacitor 51 configure a low-pass filter. Thus, the terminal IS receives the voltage obtained by removing noise components, according to the current value of the resonant current of the primary coil L1.

The current value of the resonant current increases according to the input power of the DC-DC converter 13, and the input power of the DC-DC converter 13 increases according to the power consumed by the load 14. Thus, the voltage to be applied to the terminal IS represents the voltage corresponding to the power consumption of the load 14 (i.e., the condition of the load 14).

The terminal VH is a terminal configured to receive a rectified voltage. Note that the power supply device 10 includes two rectifier circuits that rectify the AC voltage Vac, which will be described in detail later. The first one is a full-wave rectifier circuit 70 (described later) in the AC-DC converter 12 to generate the output voltage Vout1, and the full-wave rectifier circuit 70 outputs a rectified voltage Vrec1. The second one is a rectifier circuit including diodes 78, 79 (described later) for generating the voltage Vcc at the start-up of the power supply device 10, and the diodes 78, 79 output a rectified voltage Vrec2. The rectified voltage Vrec2 is a full-wave rectified voltage.

The terminal VH receives the rectified voltage Vrec2. Note that the control IC 40 charges the voltage Vcc and starts up, upon receiving the rectified voltage Vrec2 through the terminal VH, and operates based on the voltage Vcc after the start-up. The term "start-up" herein refers to the operation of the power supply device 10 from when the AC voltage Vac is applied to the power supply device 10 to when the power supply device 10 becomes able to apply the output voltage Vout2 at the predetermined level to the load 14.

The terminal HO is a terminal configured to output a drive signal Vdr1 to drive the NMOS transistor 22, and is connected to the gate of the NMOS transistor 22.

The terminal LO is a terminal configured to output a drive signal Vdr2 to drive the NMOS transistor 23, and is connected to the gate of the NMOS transistor 23.

### Details of control IC 40

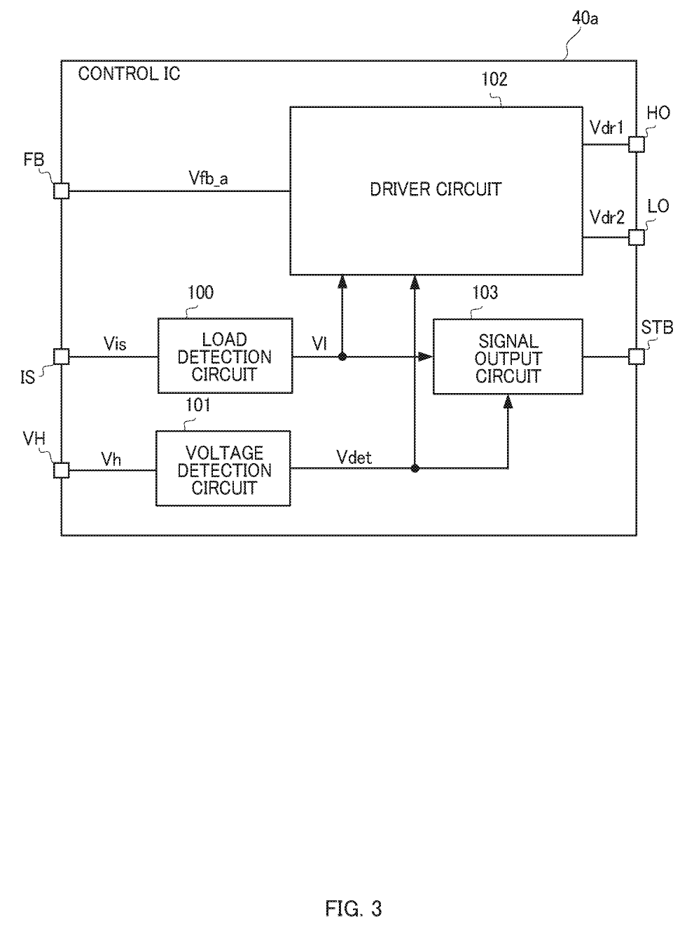

FIG. 3 is a diagram illustrating a configuration of a control IC 40a, which is one embodiment of the control IC 40. The control IC 40a includes a load detection circuit 100, a voltage detection circuit 101, a driver circuit 102, and a signal output circuit 103. Note that the terminals VCC, GND are omitted here.

The load detection circuit 100 detects whether the load 14 is in a heavy load condition, based on the voltage that is applied to the terminal IS and that is according to the power consumption of the load 14. The load detection circuit 100 outputs a signal Vl indicating the condition of the load 14 to the driver circuit 102 and the signal output circuit 103.

Here, the power consumption of the load 14 is larger when the load 14 is in the heavy load condition than when the load 14 is in a light load condition, and is even larger when the load 14 is in an overload condition. Accordingly, the voltage applied to the terminal IS represents the voltage according to the power consumption of the load 14, and thus when a voltage Vis at the terminal IS is lower than a first predetermined value, the load 14 is in the light load condition, and when the voltage Vis is higher than the first predetermined value, the load 14 is in the heavy load condition. Further, when the voltage Vis is higher than a second predetermined value that is higher than the first predetermined value, the load 14 is in the overload condition.

The voltage detection circuit 101 detects the voltage level of the AC voltage Vac, based on a voltage Vh applied to the terminal VH, that is, the voltage Vh corresponding to the voltage Vrec2 obtained by full-wave rectifying the AC voltage Vac. When an abnormality occurs in the voltage level of the AC voltage Vac, the voltage detection circuit 101 outputs an abnormality signal Vdet to the driver circuit 102 and the signal output circuit 103.

The driver circuit 102 switches the NMOS transistors 22, 23, based on the feedback
inputted thereto. Note that in response to the level of the voltage Vfb_a dropping, the driver circuit 102 outputs the drive signals Vdr1 and Vdr2 with high frequency to the NMOS transistors 22 and 23, respectively. Further, the drive signals Vdr1, Vdr2 are each a pulsed signal with a duty cycle that is generally constant (for example, 50%). Further, the driver circuit 102 complementarily changes the drive signal Vdr1 and the drive signal Vdr2, while providing a dead time such that the NMOS transistors 22, 23 are not simultaneously on.

Here, in response to the load 14 becoming the light load condition, the output voltage Vout2 exceeds the target level. Then, for example, the internal input into the voltage regulator circuit 33, configured with a shunt regulator, rises, to thereby cause the output to be constant, and thus a large amount of current is passed through the transistor inside the shunt regulator, which is not illustrated.

As a result, a large amount of current also flows through the light-emitting diode 34. Then, the phototransistor 57 causes the bias current I1 having a magnitude corresponding to the degree of amplification of the light from the light-emitting diode 34, to flow from the terminal FB to the ground, so that the feedback voltage Vfb_a drops.

Here, when the NMOS transistors 22, 23 are continuously switched, the feedback voltage Vfb_a drops in response to the level of the output voltage Vout2 exceeding the target level, and thus the switching frequency of the NMOS transistors 22, 23 rise. As a result, the output voltage Vout2 of the DC-DC converter 13, which is an LLC current-resonant converter, drops.

On the other hand, in response to the level of the output voltage Vout2 dropping below the target level, the feedback voltage Vfb_a rises, and thus the switching frequency of the NMOS transistors 22, 23 lowers. As a result, the output voltage Vout2 of the DC-DC converter 13 rises. Accordingly, when the NMOS transistors 22, 23 are continuously switched, the DC-DC converter 13 is able to generate the output voltage Vout2 at the target level.

Further, upon receiving the signal Vl, the driver circuit 102 changes the switching of the NMOS transistors 22, 23 in response to the signal Vl. Further, upon receiving the abnormality signal Vdet, the driver circuit 102 stops the switching of the NMOS transistors 22, 23.

In response to the load 14 becoming the overload condition or an abnormality occurring in the voltage level of the AC voltage Vac, the signal output circuit 103 outputs, to the power factor correction IC 75 (described later), the setting signal Sig instructing “stop” to stop the switching of the NMOS transistor 76. The setting signal Sig is a pulsed signal, and the setting signal Sig instructing the stop is outputted with a predetermined period. Meanwhile, in response to the NMOS transistors 22, 23 becoming able to be switched steadily, the signal output circuit 103 outputs the setting signal Sig instructing “restoration”. Note that the pulse width of the setting signal Sig instructing the restoration is larger than the pulse width of the setting signal Sig instructing the stop.

### Overview of AC-DC converter 12

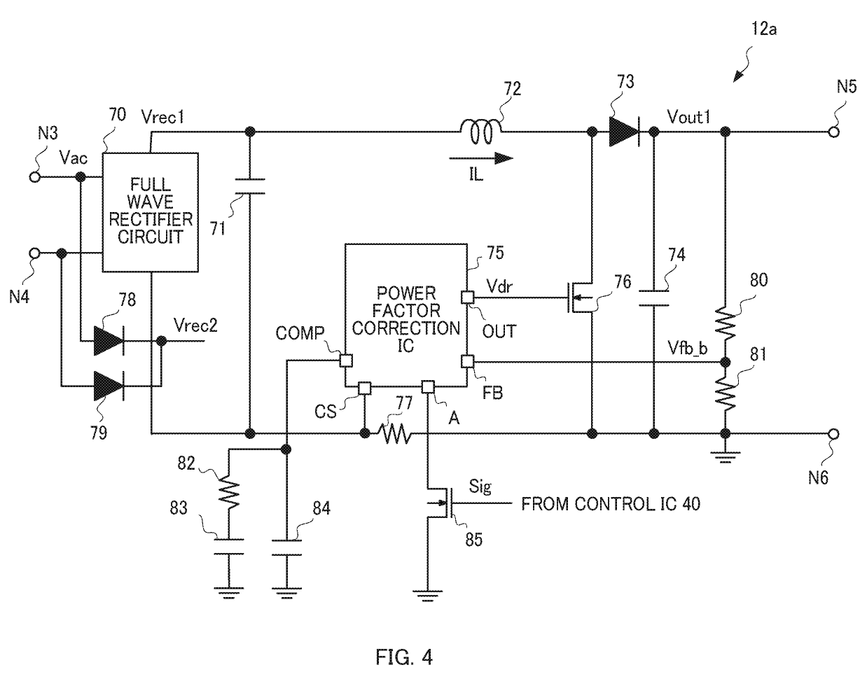

FIG. 4 is a diagram illustrating a configuration of an AC-DC converter 12a, which is one embodiment of the AC-DC converter 12. The AC-DC converter 12 is a boost chopper power supply circuit that generates the output voltage Vout1 at a target level from the AC voltage Vac of the commercial power supply.

The AC-DC converter 12a includes the full-wave rectifier circuit 70, capacitors 71, 74, 83, 84, an inductor 72, a diode 73, the power factor correction IC 75, NMOS transistors 76, 85, and resistors 77, 80 to 82.

The full-wave rectifier circuit 70 applies, to the capacitor 71 and the inductor 72, a rectified voltage Vrec1 obtained by full-wave rectifying the predetermined AC voltage Vac applied by the input line filter 11. Here, the AC voltage Vac is, for example, a voltage in a range of 100 to 240 V with a frequency in a range of 50 to 60 Hz.

The capacitor 71 is an element that smooths the rectified voltage Vrec1.

The rectified voltage Vrec1 is directly applied to the inductor 27; however, for example, the rectified voltage Vrec1 may be applied thereto through an element such as a resistor (not illustrated) and/or the like.

The inductor 72 configures a boost chopper circuit, together with the diode 73, the capacitor 74, and the NMOS transistor 76. Thus, the charge voltage of the capacitor 74 results in the DC output voltage Vout1. Note that the output voltage Vout1 is, for example, 400 V.

The power factor correction IC 75 is an integrated circuit that controls the switching of the NMOS transistor 76 such that the level of the output voltage Vout1 reaches a target level (for example, 400 V) while improving the power factor of the AC-DC converter 12. Specifically, the power factor correction IC 75 drives the NMOS transistor 76, based on an inductor current IL flowing through the inductor 72 and the output voltage Vout1.

Although the details of the power factor correction IC 75 will be described later, the power factor correction IC 75 has terminals FB, CS, COMP, A, and OUT. The power factor correction IC 75 includes terminals other than the above-described five terminals FB, CS, COMP, A, and OUT, however, other terminals are omitted here, for convenience.

The NMOS transistor 76 is a transistor to control power of the AC-DC converter 12 to the DC-DC converter 13. In an embodiment of the present disclosure, the NMOS transistor 76 is a Metal Oxide Semiconductor (MOS) transistor, but it is not limited thereto. The NMOS transistor 76 may be, for example, a bipolar transistor instead, as long as the transistor can control power. Further, the gate electrode of the NMOS transistor 76 is connected so as to be driven by the signal from the terminal OUT.

The resistor 77 is an element to detect the inductor current IL. In response to the inductor current IL flowing through the resistor 77, a negative voltage is generated at the terminal CS.

The diodes 78, 79 configure a full-wave rectifier circuit, and output the rectified voltage Vrec2.

The resistors 80, 81 configure a voltage divider circuit that divides the output voltage Vout1, to thereby generate a feedback voltage Vfb_b that is used when the NMOS transistor 76 is switched. Note that the feedback voltage Vfb_b generated at the node at which the resistors 80, 81 are connected is applied to the terminal FB.

Although details will be described later, the resistor 82 and the capacitors 83, 84 are elements for phase compensation of the power factor correction IC 75, which is to be feedback-controlled. The resistor 82 and the capacitor 83 are provided in series between the terminal COMP and the ground, and the capacitor 84 is provided in parallel with the resistor 82 and the capacitor 83.

The NMOS transistor 85 is provided between the terminal A and the ground, to change the voltage at the terminal A to the ground voltage during a time period corresponding to the pulse width of the setting signal Sig. Thus, the setting signal Sig is inputted to the terminal A.

### Configuration of power factor correction IC 75a

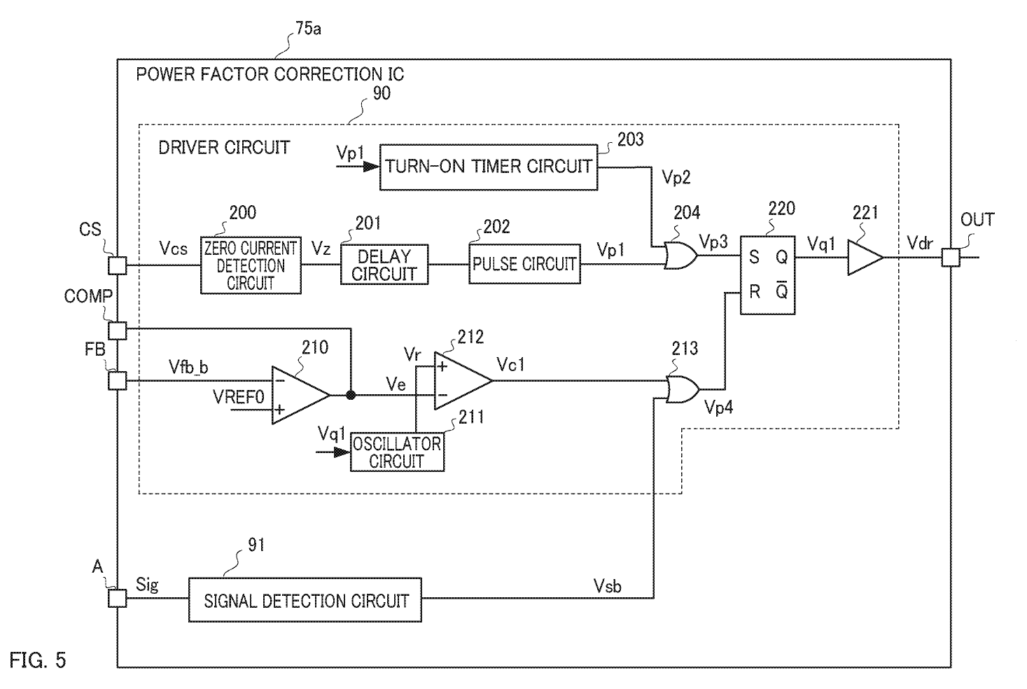

FIG. 5 is a diagram illustrating an example of a configuration of a power factor correction IC 75a, which is one embodiment of the power factor correction IC 75. The power factor correction IC 75a includes a driver circuit 90 and a signal detection circuit 91. Note that, in FIG. 5, the terminals are illustrated at positions different from those in FIG. 4, for convenience, however, wires, devices, and the like connected to the terminals are the same between FIGS. 4 and FIG. 5.

### Driver circuit 90

The driver circuit 90 is a circuit that generates a drive signal Vdr to turn on and off the NMOS transistor 76, based on the feedback voltage Vfb_b corresponding to the output voltage Vout1. The driver circuit 90 includes a zero-current detection circuit 200, a delay circuit 201, a pulse circuit 202, a turn-on timer circuit 203, OR circuits 204, 213, an error amplifier circuit 210, an oscillator circuit 211, a comparator 212, an SR flip-flop 220, and a buffer circuit 221.

The zero-current detection circuit 200 is a circuit that detects whether the current value of the inductor current IL is a "current value Ia" indicating substantially zero (hereinafter, "substantially zero" is simply referred to as zero, for convenience), based on a voltage Vcs at the terminal CS. Note that, upon detecting that the current value of the inductor current IL is the "current value Ia", which is "zero", the zero-current detection circuit 200 according to an embodiment of the present disclosure outputs a signal Vz at a high level (hereinafter referred to as high or high level). Further, the zero-current detection circuit 200 includes a comparator (not illustrated) that compares the voltage Vcs and a predetermined voltage across the resistor 77 at the time when the inductor current IL reaches the "current value Ia". Note that the “current value Ia” corresponds to a "predetermined value".

Upon receiving the high signal Vz is from the zero current detection circuit 200, the delay circuit 201 delays the received signal by a predetermined time period, and outputs a resultant signal.

Upon receiving the high signal Vz from the delay circuit 201, the pulse circuit 202 outputs a high pulse signal Vp1.

The turn-on timer circuit 203 outputs a pulse signal Vp2 to turn on the NMOS transistor 76, when the power factor correction IC 75 is started up or when the AC voltage Vac is interrupted and the pulse signal Vp1 is not outputted. Specifically, the turn-on timer circuit 203 outputs the high pulse signal Vp2 every predetermined period, when the pulse signal Vp1 is not outputted for a predetermined time period.

The OR circuit 204 calculates and outputs the logical OR of the pulse signals Vp1 and Vp2. Thus, in an embodiment of the present disclosure, the OR circuit 204 outputs the pulse signal Vp1 or the pulse signal Vp2, as a signal Vp3.

The error amplifier circuit 210 amplifies an error between the feedback voltage Vfb_b applied to the terminal FB and a predetermined reference voltage VREF0. Note that the ratio between the resistors 80 and 81 is adjusted such that the output voltage Vout1 reaches a desired voltage, based on the reference voltage VREF0. Further, the resistor 82 and the capacitors 83, 84 for phase compensation are connected, through the terminal COMP, between the output of the error amplifier circuit 210 and the ground. Here, the voltage at the node at which the output of the error amplifier circuit 210 and the terminal COMP are connected is referred to as voltage Ve.

The oscillator circuit 211 outputs a ramp wave Vr having an amplitude that gradually increases every time a high signal Vq1 is received from the SR flip-flop 220.

The comparator 212 compares the magnitudes between the voltage Ve and the ramp wave Vr, to output a signal Vc1 as a comparison result. Here, the comparator 212 has an inverting input terminal to receive the voltage Ve, and a non-inverting input terminal to receive the ramp wave Vr. Thus, when the level of the ramp wave Vr is lower than the level of the voltage Ve, the signal Vc1 will be at a low level (hereinafter referred to as low or low level), and in response to the level of the ramp wave Vr exceeding the level of the voltage Ve, the signal Vc1 goes high.

The OR circuit 213 calculates and outputs a logical OR of the signal Vc1 and a signal Vsb from the signal detection circuit 91. Thus, in response to the signal Vc1 or the signal Vsb going high, the OR circuit 213 outputs a high signal Vp4.

The signal Vp3 is inputted to the S-input of the SR flip-flop 220, and the signal Vp4 is inputted to the R-input thereof. Thus, in response to the signal Vp3 going high, the drive signal Vq1, which is the Q-output of the SR flip-flop 220 goes high. On the other hand, in response to the signal Vp4 going high, the drive signal Vq1 goes low. Note that the SR flip-flop 220 operates with reset priority, and when the signal Vp4 is high, always outputs the low signal Vq1 regardless of the signal Vp3.

The buffer circuit 221 drives the NMOS transistor 76 in response to the drive signal Vq1. Specifically, the buffer circuit 221 drives the NMOS transistor 76 having a large gate capacitance and the like, using the signal Vdr having the same logic level as that of the received signal. Further, the buffer circuit 221 turns on the NMOS transistor 76 in response to the high drive signal Vq1, and turns off the NMOS transistor 76 in response to the low drive signal Vq1.

That is, the driver circuit 90 turns on the NMOS transistor 76, in response to the inductor current IL reaching the "current value Ia", and turns off the NMOS transistor 76, in response to the time period according to the output voltage Vout1 (i.e., the feedback voltage Vfb_b) having elapsed.

The signal detection circuit 91 detects the setting signal Sig from the control IC 40. Upon receiving the setting signal Sig instructing the stop from the control IC 40, the signal detection circuit 91 outputs the high signal Vsb. On the other hand, upon receiving the setting signal Sig instructing the restoration from the control IC 40, the signal detection circuit 91 outputs a low signal Vsb.

### Operation of power factor correction IC 75a

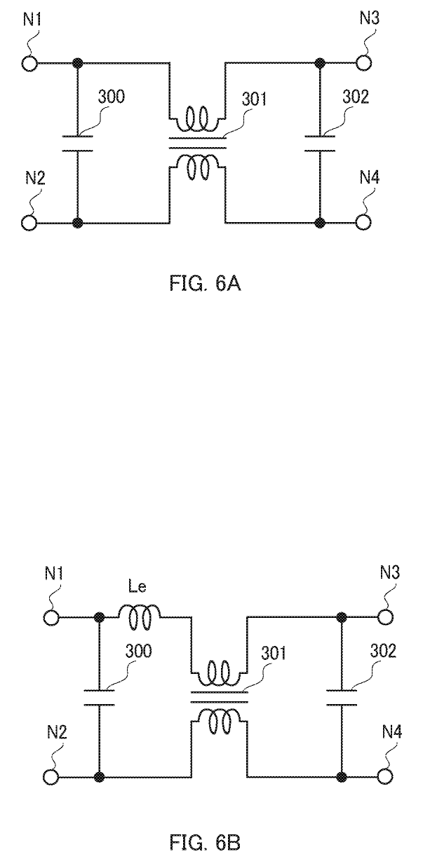

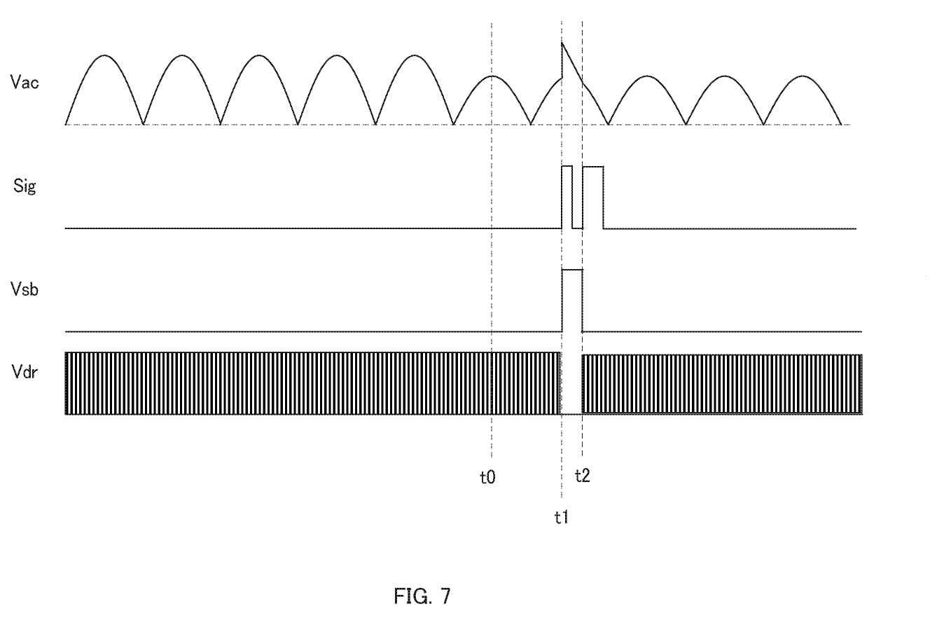

FIG. 6A is a diagram illustrating an example of a configuration of the input line filter 11, and FIG. 6B is a diagram illustrating an example of a configuration of the input line filter 11 considering a parasitic component. Further, FIG. 7 is a diagram illustrating an example of an operation of the power factor correction IC 75a. It is assumed that the voltage level of the AC voltage Vac (for example, the peak value) drops at time t0 in FIG. 7. Further, in FIG. 7, the same applies to the operation when the load 14 is in the overload condition.

The input line filter 11 includes capacitors 300, 302 and a common mode choke coil 301. Accordingly, the input line filter 11 suppresses the case where the noise from AC-DC converter 12 from is transmitted to the commercial power supply side.

Meanwhile, as illustrated in FIG. 7, when it is detected that the level of the AC voltage Vac drops at time t0, the control IC 40a outputs the setting signal Sig instructing the stop at time t1. Thus, the signal detection circuit 91 of the power factor correction IC 75a outputs the high signal Vsb, and the power factor correction IC 75a stops the switching of the NMOS transistor 76. In response to the switching of the NMOS transistor 76 being stopped, the inductor current IL does not flow and a voltage is generated at a parasitic coil Le of the common mode choke coil 301 (see FIG. 6B). Thus, in response to the switching of the NMOS transistor 76 being stopped, the voltage level of the AC voltage Vac rises.

Upon detecting that the AC voltage Vac has entered a steady state, due to a rise in the voltage level of the AC voltage Vac, at time t2, the control IC 40a outputs the setting signal Sig instructing the restoration. Upon receiving the setting signal Sig instructing the restoration, the signal detection circuit 91 of the power factor correction IC 75a outputs the low signal Vsb, and the power factor correction IC 75a resumes the switching of the NMOS transistor 76.

As such, in response to the setting signal Sig instructing the stop being outputted when the voltage level of the AC voltage Vac is high due to the presence of the parasitic coil Le of the input line filter 11, the switching of the NMOS transistor 76 results in being resumed when it should be stopped, which makes it impossible to safely control the power supply device 10.

### Embodiments

Thus, in an embodiment of the present disclosure, when it is determined that the voltage level of the AC voltage Vac has dropped below a predetermined level after receiving the setting signal Sig instructing the stop, the power factor correction IC 75 stops the switching of the NMOS transistor 76. Note that the setting signal Sig instructing the stop corresponds to a "stop signal".

### Configuration of power factor correction IC 75b

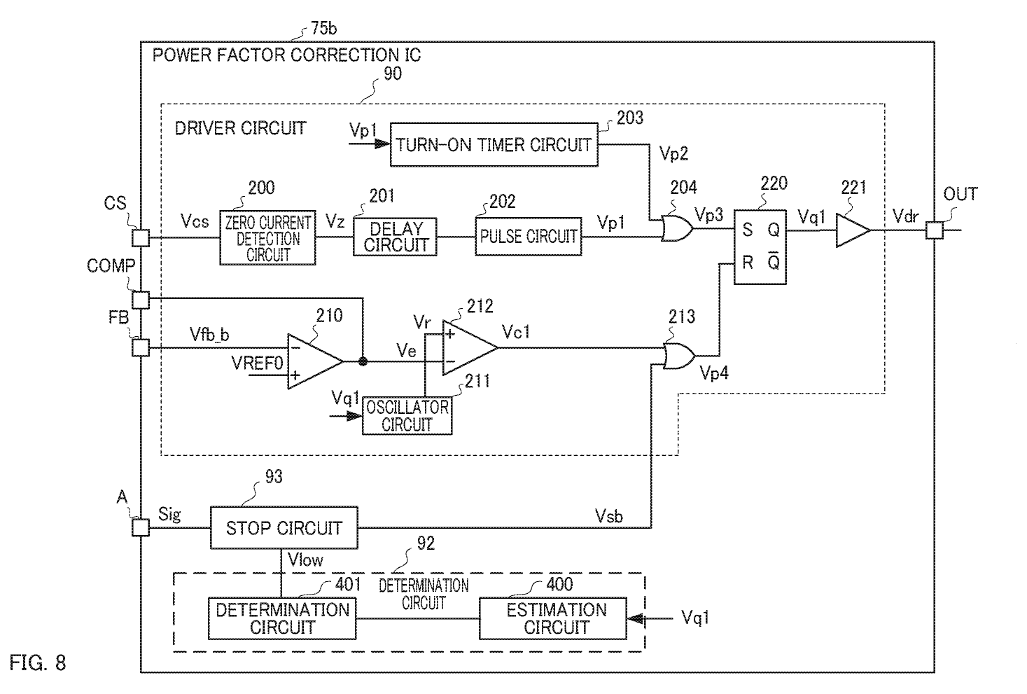

FIG. 8 is a diagram illustrating an example of a configuration of a power factor correction IC 75b, which is one embodiment of the power factor correction IC 75. The power factor correction IC 75b includes the driver circuit 90, a determination circuit 92, and a stop circuit 93. Note that, in FIG. 8, the terminals are illustrated at positions different from those in FIG. 4 for convenience, however, wires, devices, and the like connected to the terminals are the same between FIGS. 4 and FIG. 5. Further, the terminal A corresponds to a "first terminal", and the driver circuit 90 corresponds to a "driver circuit " or a "second driver circuit".

The determination circuit 92 determines the voltage level of the AC voltage Vac, based on a change in the voltage level of the AC voltage Vac. Specifically, the determination circuit 92 determines whether the voltage level of the AC voltage Vac is lower than a predetermined level V0, and outputs a high signal Vlow when the voltage level of the AC voltage Vac is lower than the predetermined level V0. On the other hand, the determination circuit 92 outputs a low signal Vlow when the voltage level of the AC voltage Vac is higher than the predetermined level V0. The determination circuit 92 includes an estimation circuit 400 and a determination circuit 401. The determination circuit 92 corresponds to a "first determination circuit".

The estimation circuit 400 estimates the voltage level of the AC voltage Vac. Specifically, the estimation circuit 400 estimates the voltage level of the AC voltage Vac, based on the switching (specifically, OFF period) of the NMOS transistor 76, when the AC-DC converter 12 is operating in a critical mode.

Note that when the output voltage Vout1 reaches the target level, the ON period of the NMOS transistor 76 is substantially constant. Then, in response to the ON period being substantially constant and the voltage level of the AC voltage Vac rising, the peak value of the inductor current IL increases, and in response to the voltage level of the AC voltage Vac dropping, the peak value of the inductor current IL decreases. The higher the peak value of the inductor current IL, the longer the time period (i.e., the OFF period) from when the NMOS transistor 76 is turned off until when the inductor current IL reaches the "current value Ia". Accordingly, the estimation circuit 400 can estimate the voltage level of the AC voltage Vac, based on the length of the OFF period (or the ratio of the OFF period/(the ON period + the OFF period)).

The determination circuit 401 determines whether the voltage level of the AC voltage Vac is lower than the predetermined level V0, based on the estimation result of the estimation circuit 400. Specifically, the determination circuit 401 outputs the high signal Vlow when the voltage level of the AC voltage Vac is lower than the predetermined level V0. On the other hand, the determination circuit 401 outputs the low signal Vlow when the voltage level of the AC voltage Vac is higher than the predetermined level V0. Note that the determination circuit 401 corresponds to a "second determination circuit".

The stop circuit 93 controls the switching of the NMOS transistor 76 in response to the setting signal Sig. Specifically, upon receiving the high signal Vlow after receiving the setting signal Sig instructing the stop, the stop circuit 93 causes the driver circuit 90 to stop the switching of the NMOS transistor 76.

Meanwhile, upon receiving the setting signal Sig instructing the stop for a time period P0, the stop circuit 93 causes the driver circuit 90 to stop the switching of the NMOS transistor 76. This is performed to suppress the case where the switching of the NMOS transistor 76 fails to stop when the voltage level of the AC voltage Vac cannot be properly detected.

Note that the AC-DC converter 12 corresponds to a "first power supply circuit", and the DC-DC converter 13 corresponds to a "second power supply circuit". Further, the NMOS transistor 76 corresponds to a "first transistor", the power factor correction IC 75 corresponds to a "first integrated circuit", the output voltage Vout1 corresponds to a "first output voltage", the control IC 40 corresponds to a "second integrated circuit", and the output voltage Vout2 corresponds to a "second output voltage".

### Operation of power factor correction IC 75b

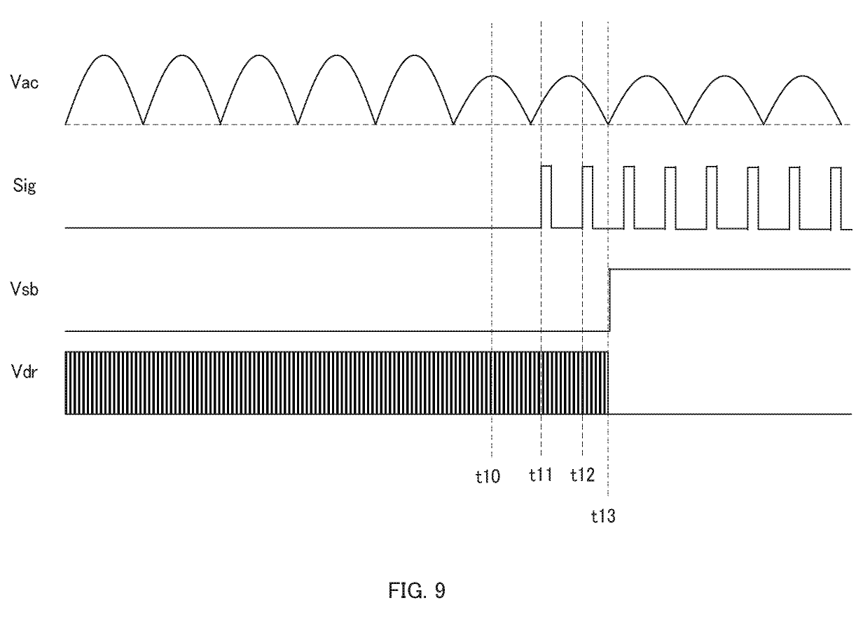

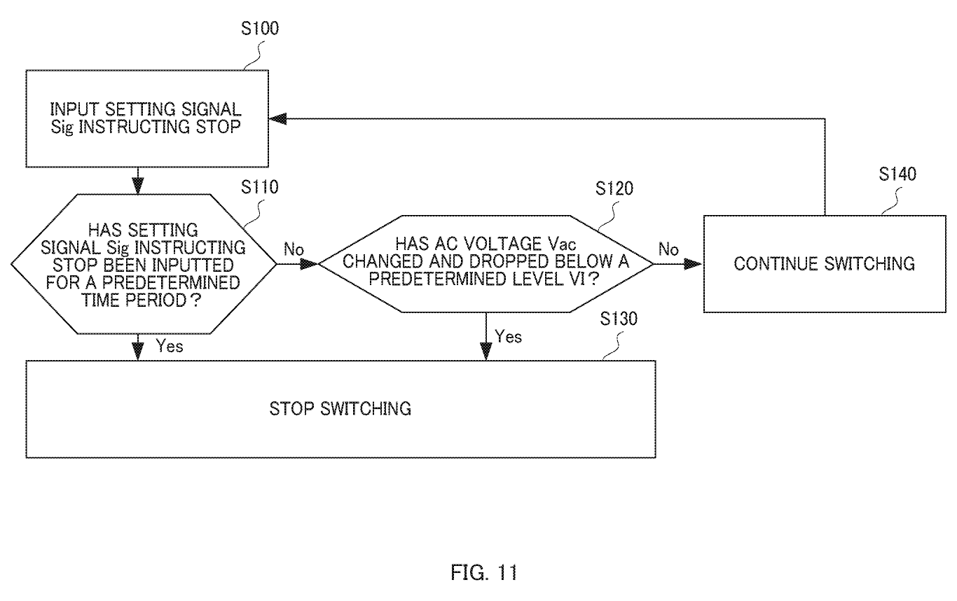

FIG. 9 is a diagram illustrating an example of an operation of the power factor correction IC 75b. It is assumed that the voltage level of the AC voltage Vac (for example, the peak value) drops at time t10. Further, in FIG. 9, the same applies to the operation when the load 14 is in the overload condition. The operation in FIG. 9 will be described with reference to FIG. 11.

When it is detected that the level of the AC voltage Vac has dropped at time t10, the control IC 40a outputs the setting signal Sig instructing the stop at time t11, and the setting signal Sig instructing the stop is inputted to the power factor correction IC 75b (Step S100). However, since the setting signal Sig instructing the stop has not been inputted for the predetermined time period P0 (No in Step S110), and the AC voltage Vac is still greater than the predetermined level V0 (No in Step S120), and thus the power factor correction IC 75b continues the switching of the NMOS transistor 76 (Step 140).

At time t12, at which the predetermined period has elapsed since time t11, the control IC 40a outputs the setting signal Sig instructing the stop.

Thereafter, at time t13, at which the AC voltage Vac has dropped below the predetermined level V0 (Yes in Step S120), the stop circuit 93 of the power factor correction IC 75b outputs the high signal Vsb, and the power factor correction IC 75b stops the switching of the NMOS transistor 76 (Step S130).

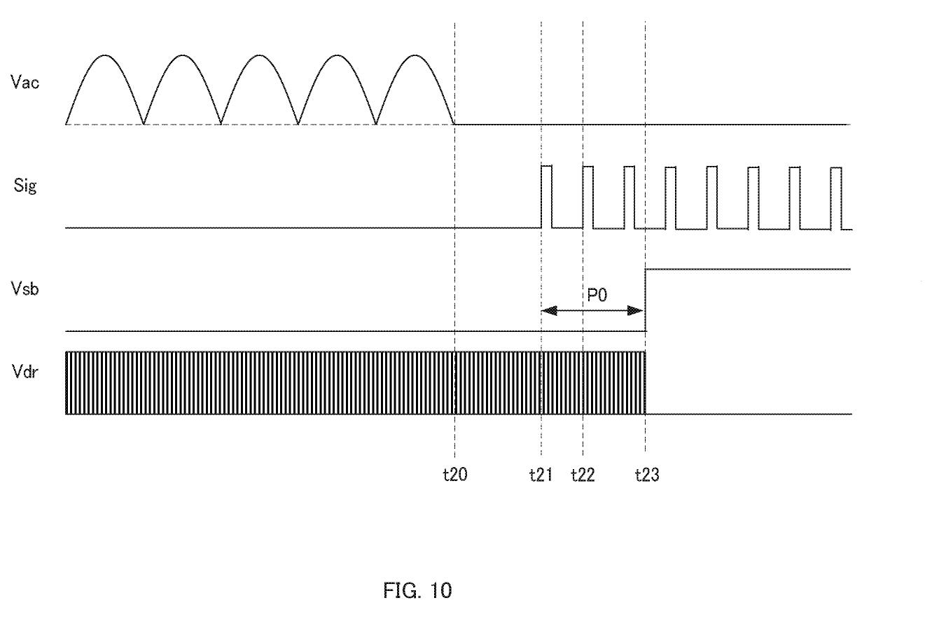

FIG. 10 is a diagram illustrating an example of an operation of the power factor correction IC 75b. It is assumed that the AC voltage Vac is no longer inputted at time t20. The operation in FIG. 10 will be described with reference to FIG. 11.

When it is detected that the AC voltage Vac is no longer inputted at time t20, the control IC 40a outputs the setting signal Sig instructing the stop at time t21, and the setting signal Sig instructing the stop is inputted to the power factor correction IC 75b (Step S100). However, the setting signal Sig instructing the stop has not been inputted for the predetermined time period P0 (No in Step S110), and the AC voltage Vac has not changed (No in Step S120), and thus the power factor correction IC 75b continues the switching of the NMOS transistor 76 (Step 140).

At time t22, at which the predetermined period has elapsed since time t21, the control IC 40a outputs the setting signal Sig instructing the stop. Hereinafter, similarly, the control IC 40a outputs the setting signal Sig instructing the stop.

Thereafter, at time t23, at which the predetermined time period P0 has elapsed since time t21, the predetermined time period P0 has elapsed since the setting signal Sig instructing the stop was inputted (Yes in Step S110), and thus the stop circuit 93 of the power factor correction IC 75b outputs the high signal Vsb, and the power factor correction IC 75b stops the switching of the NMOS transistor 76 (Step S130).

This makes it possible to provide an integrated circuit capable of controlling the operation of a power supply circuit in the event of an abnormality.

### Modifications

### Configuration of control IC 40b

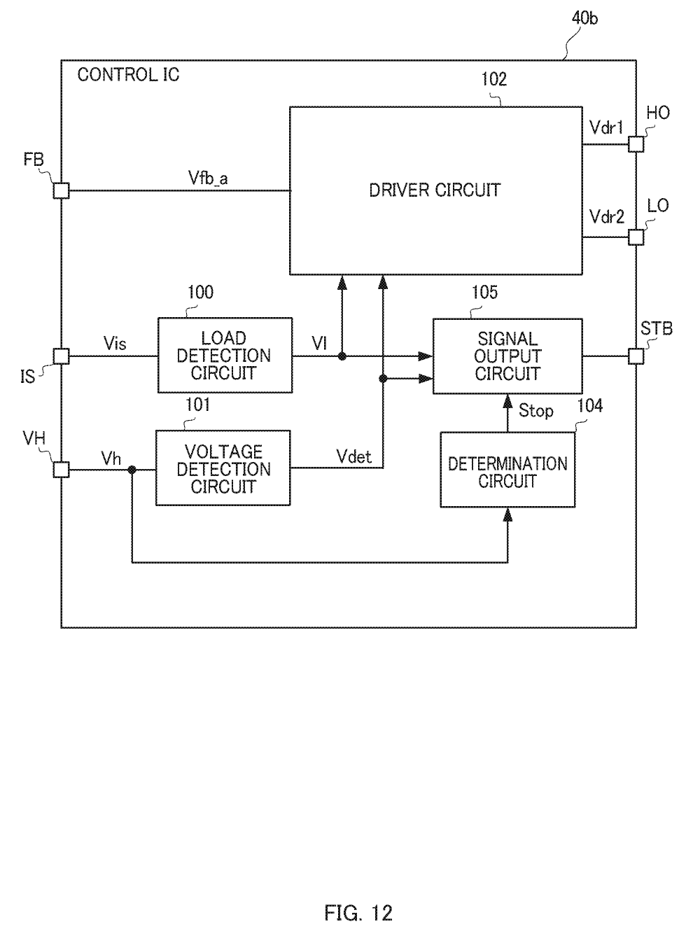

FIG. 12 is a diagram illustrating an example of a control IC 40b, which is one embodiment of the control IC 40. The control IC 40b includes the load detection circuit 100, the voltage detection circuit 101, the driver circuit 102, a determination circuit 104, and a signal output circuit 105. Note that the terminals VCC, GND are omitted here.

The determination circuit 104 determines whether the AC voltage Vac is lower than the predetermined level V0, based on a change in the voltage level of the AC voltage Vac. Upon determining that the AC voltage Vac is lower than the predetermined level V0, based on the detection of the AC voltage Vac, the determination circuit 104 outputs a high signal Stop. When the AC voltage Vac is lower than the predetermined level V0, this corresponds to a low phase angle state such as a state in which the AC voltage Vac is substantially 0 V. On the other hand, upon determining that the AC voltage Vac is higher than the predetermined level V0, the determination circuit 104 outputs a low signal Stop. Note that the determination circuit 104 corresponds to a "third determination circuit".

In response to the AC voltage Vac dropping below the predetermined level V0 after it is detected that the load 14 has become the overload condition, the signal output circuit 105 outputs, the power factor correction IC 75 (described later), the setting signal Sig instructing the stop to stop the switching of the NMOS transistor 76. Further, upon receiving the abnormality signal Vdet, the signal output circuit 105 outputs, the power factor correction IC 75 (described later), the setting signal Sig instructing the stop to stop the switching of the NMOS transistor 76. Note that the terminal VH provided to the control IC 40 corresponds to a "third terminal".

### Operation of control IC 40b

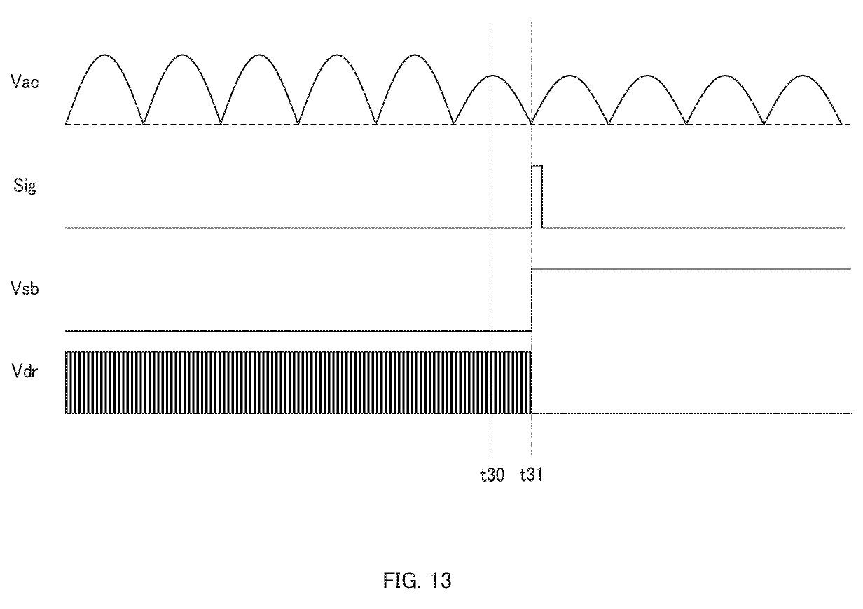

FIG. 13 is a diagram illustrating an example of an operation of the control IC 40b. It is assumed that the voltage level of the AC voltage Vac (for example, the peak value) drops at time t30.

When it is detected that the voltage level of the AC voltage Vac drops at time t30, the voltage level of the AC voltage Vac drops below the predetermined level V0, and, at time t31 at which the AC voltage Vac is in the low phase angle state such as the state in which the AC voltage Vac is substantially 0 V, the control IC 40b outputs the setting signal Sig instructing the stop, and the setting signal Sig instructing the stop is inputted to the power factor correction IC 75a. Thus, the signal detection circuit 91 of the power factor correction IC 75a outputs the high signal Vsb, and the power factor correction IC 75a stops the switching of the NMOS transistor 76. Note that the signal detection circuit 91 corresponds to a "stop circuit".

This makes it possible to provide an integrated circuit capable of controlling the operation of a power supply circuit in the event of an abnormality.

### Overview of AC-DC converter 12b

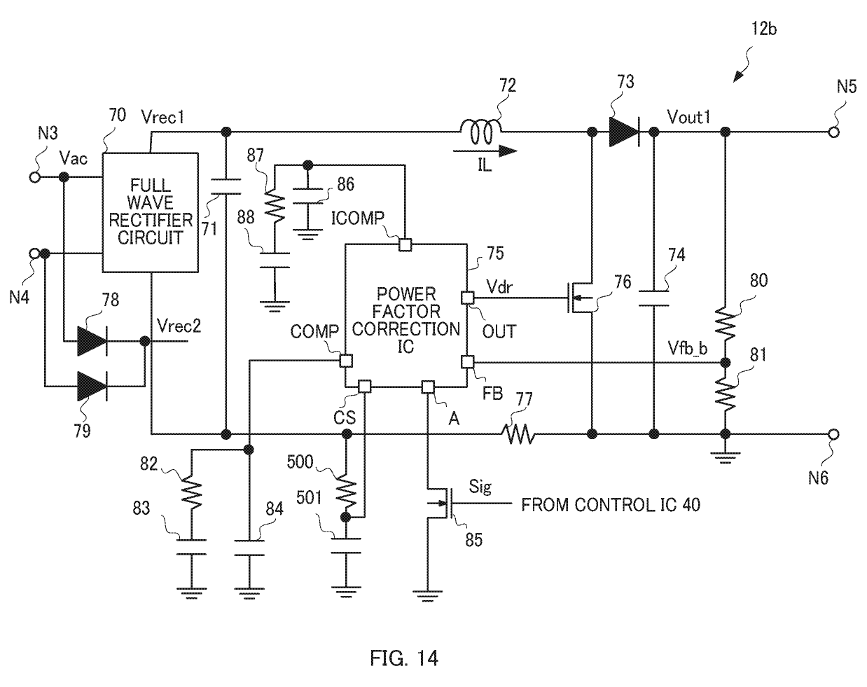

FIG. 14 is a diagram illustrating an example of an AC-DC converter 12b, which is one embodiment of the AC-DC converter 12. Note the power factor correction IC 75 in FIG. 14 is a power factor correction IC 75c, which is one embodiment of operating in a current continuous mode.

The AC-DC converter 12b includes the full-wave rectifier circuit 70, the capacitors 71, 74, 83, 84, capacitors 86, 88, 501, the inductor 72, the diode 73, the power factor correction IC 75, the NMOS transistors 76, 85, and the resistors 77, 80 to 82, and resistors 87, 500.

Although the details of the power factor correction IC 75c will be described later, the power factor correction IC 75c has the terminals FB, CS, COMP, A, and OUT, and a terminal ICOMP. Note that the power factor correction IC 75 has terminals other than the above-described six terminals FB, CS, COMP, A, OUT, and ICOMP, however, other terminals are omitted here, for convenience.

Although described later in detail, the capacitors 86, 88 and the resistor 87 are elements for phase compensation of the power factor correction IC 75, which is feedback-controlled. The resistor 87 and the capacitor 88 are provided in series between the terminal ICOMP and the ground, and the capacitor 86 is provided in parallel with the resistor 87 and the capacitor 88.

The resistor 500 and the capacitor 501 configure an integrator circuit that integrates the voltage generated across the resistor 77, and suppresses the ripple component of the voltage generated across the resistor 77. Accordingly, the voltage applied to the terminal CS results in the voltage having an AC component of the rectified voltage Vrec1, which will be described in detail later.

### Configuration of power factor correction IC 75c

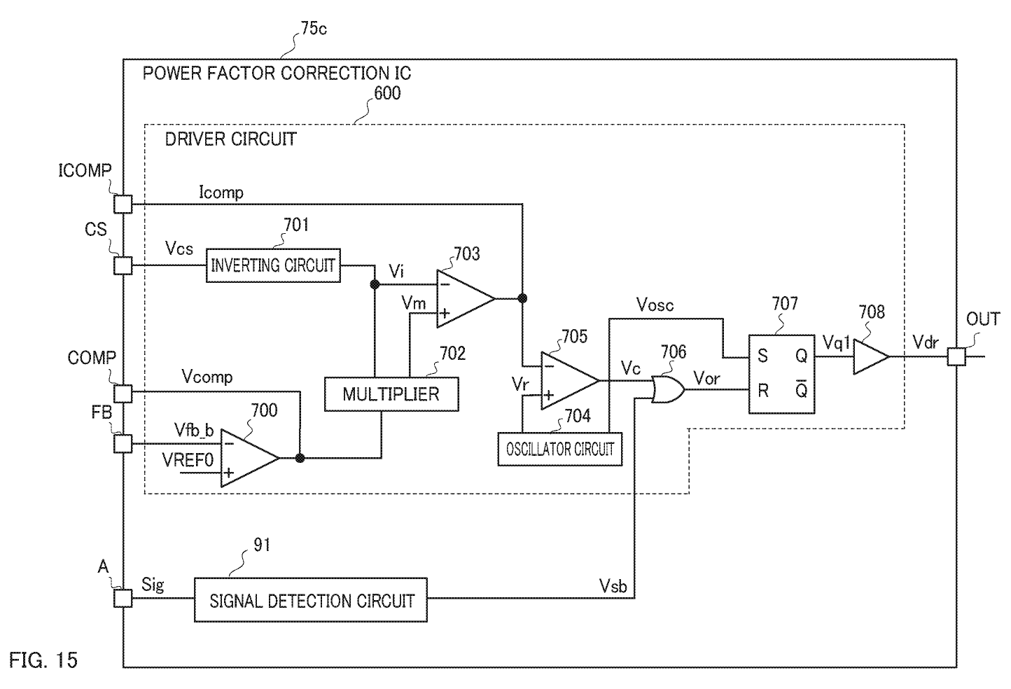

FIG. 15 is a diagram illustrating an example of a configuration of a power factor correction IC 75c, which is one embodiment of the power factor correction IC 75. The power factor correction IC 75c includes a driver circuit 600 and the signal detection circuit 91. Note that, in FIG. 15, the terminals are illustrated at positions different from those in FIG. 14, for convenience, however, wires, devices, and the like connected to the terminals are the same between FIG. 14 and FIG. 15.

The driver circuit 600 drives the NMOS transistor 76 to operate the AC-DC converter 12b in a current continuous mode. The driver circuit 600 includes an error amplifier circuits 700, 703, an inverting circuit 701, a multiplier 702, an oscillator circuit 704, a comparator 705, an OR circuit 706, an SR flip-flop 707, and a buffer circuit 708.

The error amplifier circuit 700 is a circuit that amplifies an error between the feedback voltage Vfb_b applied to the terminal FB and the predetermined reference voltage VREF0. External circuits connected to the terminals FB, COMP are the same as those in the power factor correction IC 75b, and thus an explanation thereof is omitted.

The inverting circuit 701 inverts the voltage generated across the resistor 77, and outputs a result, as a voltage Vi, to the multiplier 702 and the error amplifier circuit 703.

The multiplier 702 outputs a voltage Vm, based on the voltages Vcomp, Vi. Specifically, the multiplier 702 multiplies the voltage Vcomp by the voltage Vi, to thereby output a result to the error amplifier circuit 703 as the voltage Vm.

The error amplifier circuit 703 is a circuit that amplifies an error between the voltage Vi and the voltage Vm. Note that the error amplifier circuit 703 determines the peak value of the inductor current IL, based on voltage Vm, such that the output voltage Vout1 reaches a desired voltage. Further, the capacitors 86, 88 and the resistor 87 for phase compensation are connected through the terminal ICOMP between the output of the error amplifier circuit 703 and the ground. Here, the voltage at the node at which the output of the error amplifier circuit 703 and the terminal ICOMP are connected is referred to as voltage Icomp.

The oscillator circuit 704 outputs a sawtooth-wave-shaped voltage Vr at a predetermined frequency Fpwm, and outputs a pulse signal Vosc when the voltage Vr begins to rise.

The comparator 705 compares the voltage Icomp and the voltage Vr. Specifically, in response to the voltage Vr exceeding the voltage Icomp, the comparator 705 outputs a high signal Vc to turn off the NMOS transistor 76. On the other hand, when the voltage Vr is lower than the voltage Vcomp, the comparator 705 outputs a low signal Vc. With the comparator 705 operating as such, the peak value of the inductor current IL is determined such that the NMOS transistor 76 is switched at the switching frequency of the predetermined frequency Fpwm and the output voltage Vout1 reaches the target level.

The OR circuit 706 performs a logical OR operation between the signal Vc and the signal Vsb from the signal detection circuit 91. Specifically, upon receiving the high signal Vc or the high signal Vsb, the OR circuit 706 outputs a signal Vor to turn off the NMOS transistor 76.

The RS flip-flop 707 outputs the drive signal Vq1 to drive the NMOS transistor 76. Specifically, upon receiving the signal Vosc, the SR flip-flop 707 outputs the high drive signal Vq1 to turn on the NMOS transistor 76. On the other hand, upon receiving the high signal Vor, the SR flip-flop 707 outputs the low drive signal Vq1 to turn off the NMOS transistor 76.

The buffer circuit 708 drives the NMOS transistor 76 in response to the drive signal Vq1. Specifically, the buffer circuit 708 drives the NMOS transistor 76 having a large gate capacitance and the like, using the signal Vdr having the same logic level as that of the received signal. Further, the buffer circuit 708 turns on the NMOS transistor 76 in response to the high drive signal Vq1, and turns off the NMOS transistor 76 in response to the low drive signal Vq1.

Note that when the control IC 40b and the power factor correction IC 75c are operated in combination, the operation illustrated in FIG. 13 is obtained, and thus further explanation of the operation is omitted. This makes it possible to provide an integrated circuit capable of controlling the operation of a power supply circuit in the event of an abnormality.

### Overview of DC-DC converter 13b

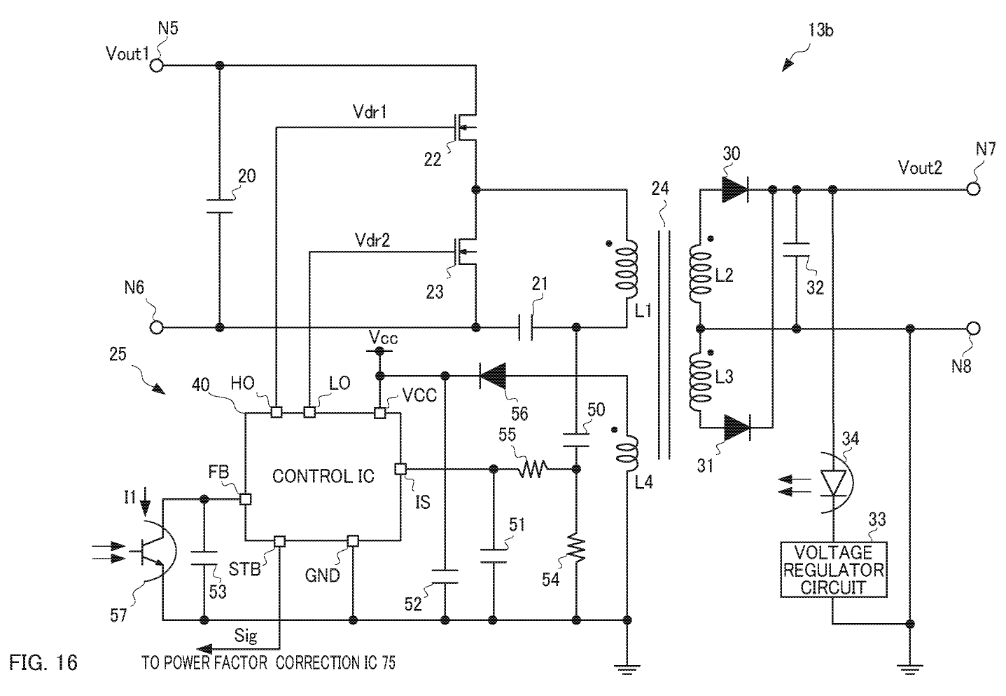

FIG. 16 is a diagram illustrating an example of a configuration of a DC-DC converter 13b, which is one embodiment of the DC-DC converter 13. Note that the control IC 40 in FIG. 16 differs from the control IC 40 in FIG. 2 in that the control IC 40 in FIG. 16 does not have the terminal VH.

### Configuration of control IC 40c

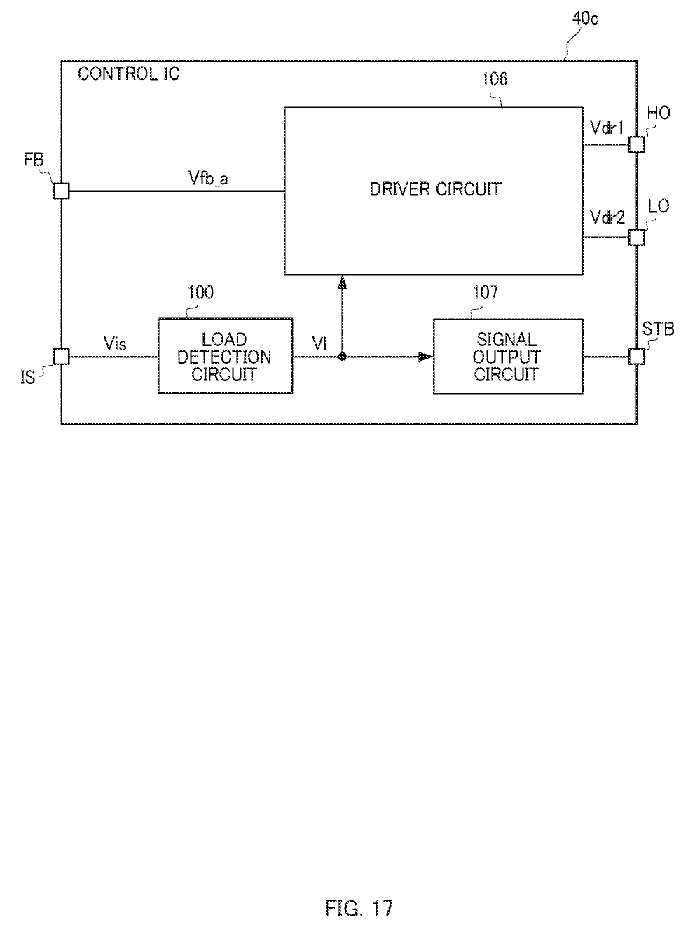

FIG. 17 is a diagram illustrating an example of a configuration of a control IC 40c, which is one embodiment of the control IC 40. The control IC 40c includes the load detection circuit 100, a driver circuit 106, and a signal output circuit 107.

The driver circuit 106 switches the NMOS transistors 22, 23, based on the received feedback voltage Vfb_a. Further, upon receiving the signal Vl, the driver circuit 106 changes the switching of the NMOS transistors 22, 23 in response to the signal Vl.

In response to the load 14 becomes the overload condition, the signal output circuit 107 outputs, to the power factor correction IC 75 (described later), the setting signal Sig instructing the stop such that the switching of the NMOS transistor 76 is stopped.

### Overview of AC-DC converter 12c

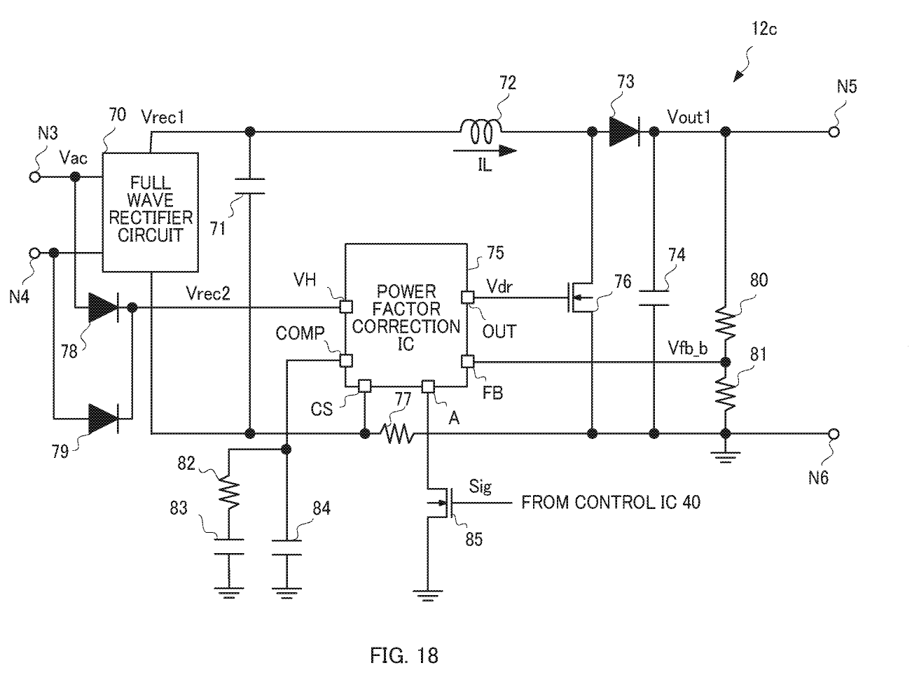

FIG. 18 is a diagram illustrating an example of a configuration of an AC-DC converter 12c, which is one embodiment of the AC-DC converter 12. Note that the power factor correction IC 75 in FIG. 18 differs from the power factor correction IC 75 in FIG. 4 in that the power factor correction IC 75 in FIG. 18 has the terminal VH. Further, the rectified voltage Vrec2 is applied to the terminal VH.

### Configuration of power factor correction IC 75d

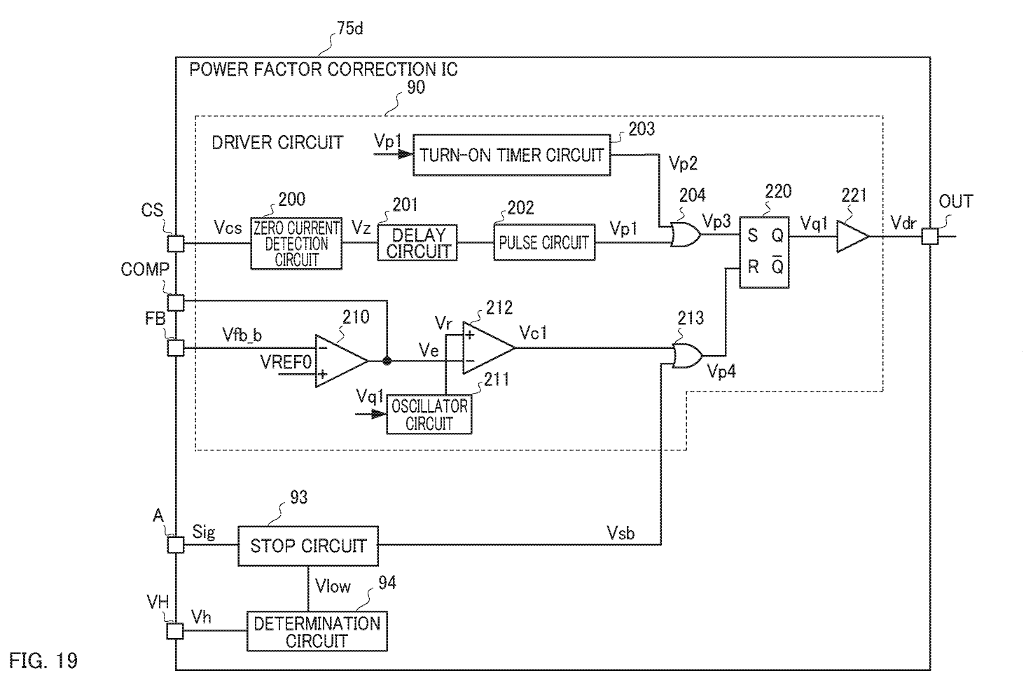

FIG. 19 is a diagram illustrating an example of a configuration of a power factor correction IC 75d, which is one embodiment of the power factor correction IC 75. The power factor correction IC 75d includes the driver circuit 90, the stop circuit 93, and a determination circuit 94.

The determination circuit 94 determines whether the voltage level of the AC voltage Vac is lower than the predetermined level V0, based on the voltage Vh corresponding to the rectified voltage Vrec2 applied to the terminal VH. Note that the terminal VH provided to the power factor correction IC 75 corresponds to a "second terminal", and the determination circuit 94 corresponds to the "first determination circuit".

Note that when the control IC 40c and the power factor correction IC 75d are operated in combination, the operations illustrated in FIGS. 9 - 11 are obtained, and thus further explanation of the operation is omitted. This makes it possible to provide an integrated circuit capable of controlling the operation of a power supply circuit in the event of an abnormality.

### Overview of AC-DC converter 12d

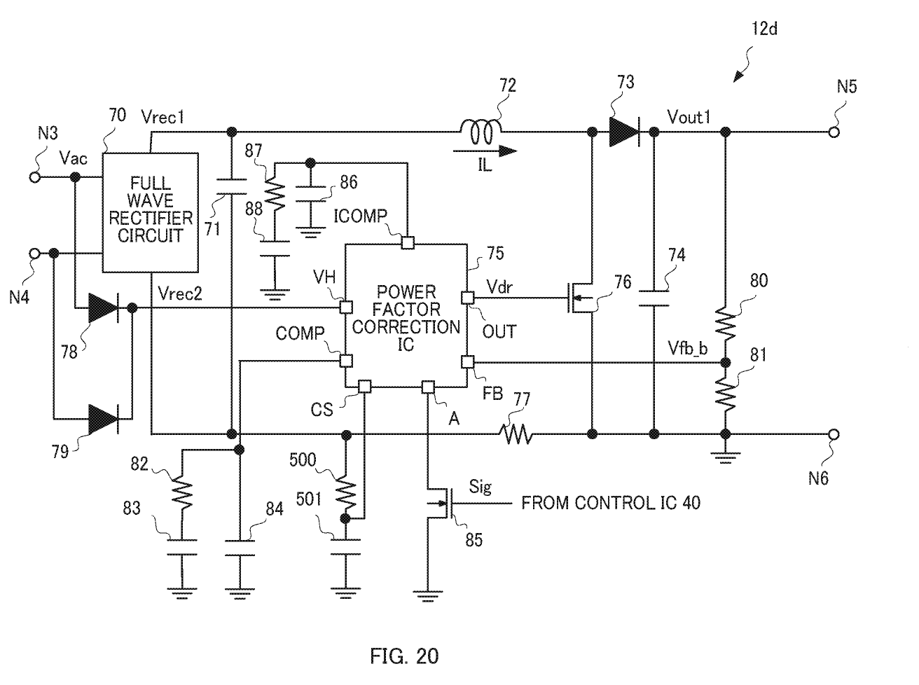

FIG. 20 is a diagram illustrating an example of a configuration of an AC-DC converter 12d, which is one embodiment of the AC-DC converter 12. Note that the power factor correction IC 75 in FIG. 20 differs from the power factor correction IC 75 in FIG. 14 in that the power factor correction IC 75 in FIG. 20 has the terminal VH. Further, the rectified voltage Vrec2 is applied to the terminal VH.

### Configuration of power factor correction IC 75e

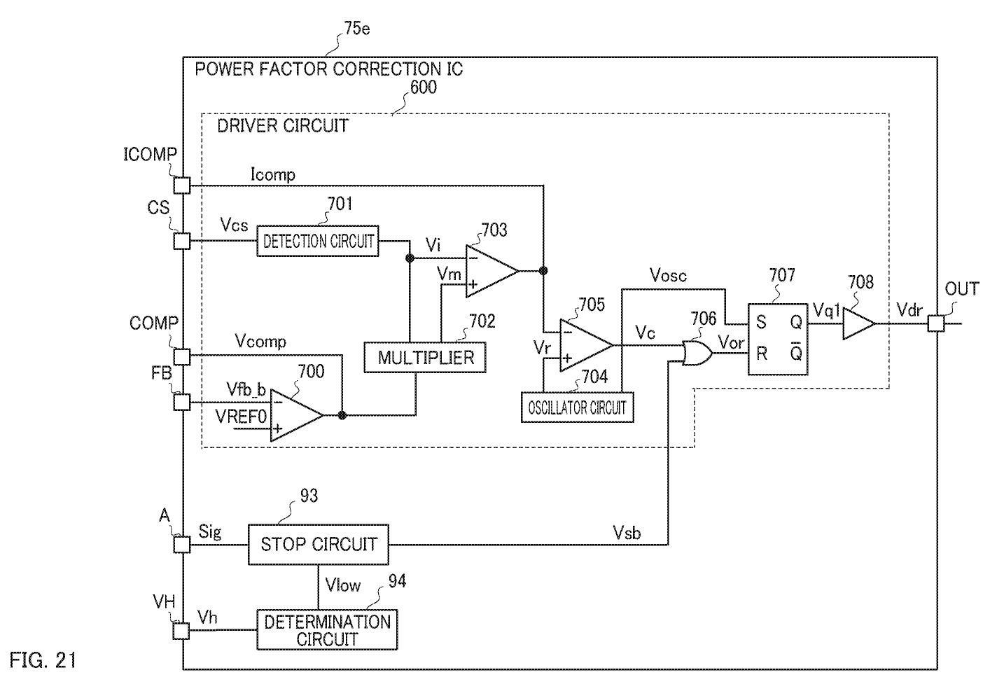

FIG. 21 is a diagram illustrating an example of a configuration of a power factor correction IC 75e, which is one embodiment of the power factor correction IC 75. The power factor correction IC 75e includes the driver circuit 600, the stop circuit 93, and the determination circuit 94.

Note that when the control IC 40c and the power factor correction IC 75e are operated in combination, the operations illustrated in FIGS. 9 - 11 are obtained, and thus further explanation of the operation is omitted. This makes it possible to provide an integrated circuit capable of controlling the operation of a power supply circuit in the event of an abnormality.

### Operation of power factor correction IC 75b during instantaneous power failure

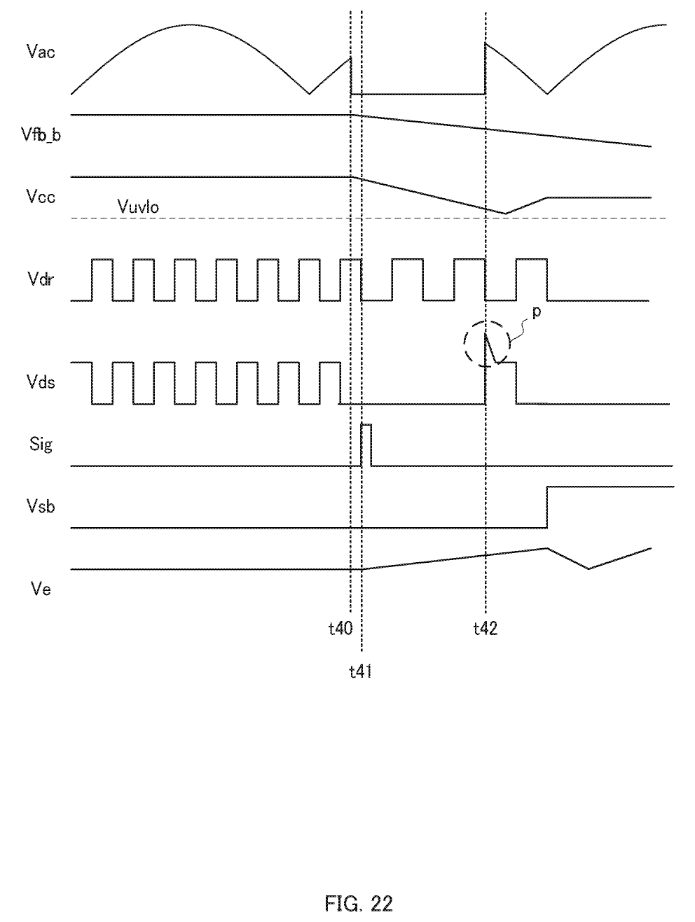

FIG. 22 is a diagram illustrating an example of an operation of the power factor correction IC 75b during an instantaneous power failure. Here, the "instantaneous power failure" refers to the case where the time period from when the AC voltage Vac stops to when it is restored is shorter than the time period from when the AC voltage Vac stops to when the power supply voltage Vcc reaches a voltage level Vuvlo. Further, the voltage level Vuvlo is the voltage level at which the power factor correction IC 75b is reset when the voltage level of the power supply voltage Vcc reaches the voltage level Vuvlo.

At time t40, the AC voltage Vac stops. At time t41, at which the control IC 40a detects that the AC voltage Vac has stopped, the control IC 40a outputs the setting signal Sig instructing the stop. In this event, the AC voltage Vac is stopped, and thus the output voltage Vout1 drops. Thus, the error amplifier circuit 210 raises the voltage Ve. Accordingly, the ON time of the NMOS transistor 27 gradually increases.

Then, at time t42, at which the AC voltage Vac is restored, the ON period of the NMOS transistor 76 has become longer, resulting in the higher peak value of the inductor current IL. Thus, in response to the NMOS transistor 76 being turned off, a surge voltage will occur in the drain-source voltage Vds of the NMOS transistor 76 as given using a symbol p, due to the influence of the wiring inductance on the drain side and the source side of the NMOS transistor 76, which may damage the NMOS transistor 76 in some cases.

Further, the surge voltage tends to be larger, when the wiring inductance on the drain side and the source side of the NMOS transistor 76 are large, or when the load is heavy and the ON period is long, or the like as well. Thus, the NMOS transistor 76 may be damaged. Further, the wiring inductance varies depending on a power supply board, and thus the voltage level of the surge voltage varies depending on the power supply board.

### Configuration of power factor correction IC 75f

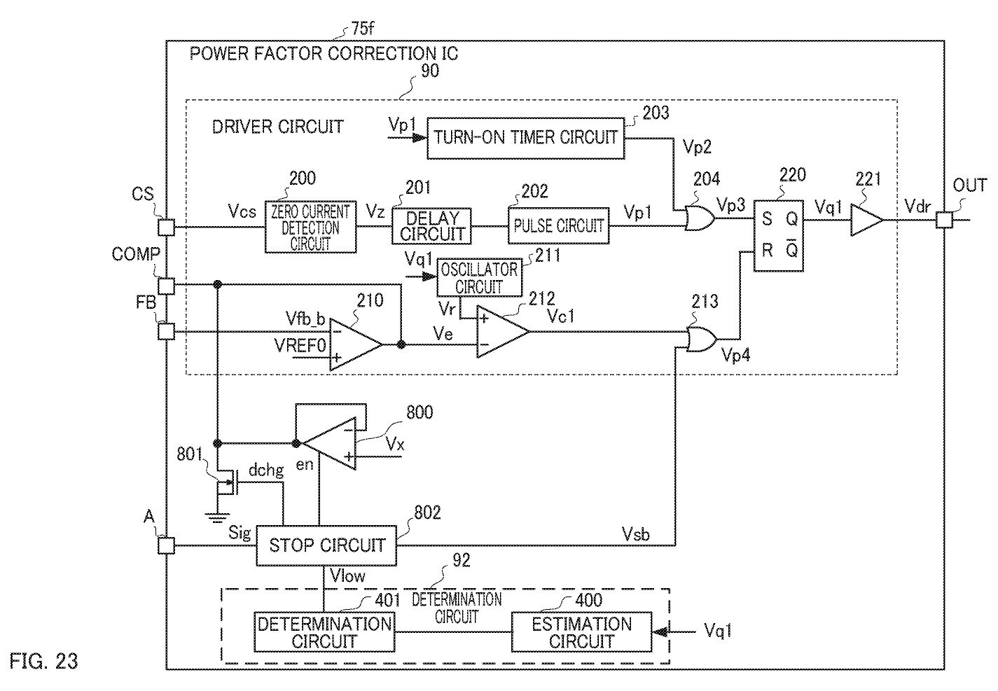

FIG. 23 is a diagram illustrating an example of a configuration of a power factor correction IC 75f, which is one embodiment of the power factor correction IC 75. The power factor correction IC 75f lowers the voltage Ve during an instantaneous power failure of the AC voltage Vac. The power factor correction IC 75f includes the driver circuit 90, the determination circuit 92, an operational amplifier 800, an NMOS transistor 801, and a stop circuit 802. Note that, in FIG. 23, the terminals are illustrated at positions different from those in FIG. 4, for convenience, however, wires, devices, and the like connected to the terminals are the same between FIGS. 4 and FIG. 23.

The operational amplifier 800 configures a voltage follower and lowers the voltage Ve to a voltage level Vx, during an instantaneous power failure of the AC voltage Vac (for example, while a high enable signal en is being received). Here, the voltage level Vx is a voltage level at which the NMOS transistor 76 will not be damaged even if the surge voltage occurs in the voltage Vds of the NMOS transistor 76 after the AC voltage Vac is restored.

Further, the operational amplifier 800 causes the driver circuit 90 to switch the NMOS transistor 76 such that the ON period thereof will be shorter than a predetermined time period, based on the voltage Ve, after the setting signal Sig instructing the stop is inputted, until the switching of the NMOS transistor 76 is stopped.

Here, the "predetermined time period" refers to the time period in which the NMOS transistor 76 will not be damaged even if the surge voltage occurs in the voltage Vds of the NMOS transistor 76 after the AC voltage Vac is restored. Further, the operational amplifier 800 maintains the voltage Ve such that the ON period of the NMOS transistor 76 will be shorter than the predetermined time period, based on the output from the stop circuit 802 (described below). Note that the operational amplifier 800 corresponds to a "control circuit", and the voltage Ve corresponds to a "first voltage".

The NMOS transistor 801 discharges the capacitors 83, 84 through the terminal COMP, based on the output from the stop circuit 802. Specifically, the NMOS transistor 801 discharges the capacitors 83, 84, in response to the NMOS transistor 801 receiving a high signal dchg indicating that the stop circuit 802 has detected the setting signal Sig instructing the restoration. Note that the capacitors 83, 84 correspond to a "capacitor", the terminal COMP corresponds to a "third terminal", and the NMOS transistor 801 corresponds to a "discharge circuit".

The stop circuit 802 determines whether the setting signal Sig is instructing the stop or the restoration, and controls the operational amplifier 800 and the NMOS transistor 801. Specifically, in response to the setting signal Sig instructing the stop being inputted to the terminal A, the stop circuit 802 outputs the high signal en to cause the operational amplifier 800 to maintain the level of the voltage Ve, and in response to the switching of the NMOS transistor 76 being stopped based on the setting signal Sig instructing the stop, the stop circuit 802 outputs a low signal en.

Further, in response to the setting signal Sig instructing the restoration being inputted to the terminal A, the stop circuit 802 outputs the high signal dchg to operate the NMOS transistor 801. Note that the setting signal Sig instructing the restoration corresponds to a "start signal".

Further, upon receiving the high signal Vlow after receiving the setting signal Sig instructing the stop, the stop circuit 802 causes the driver circuit 90 to stop the switching of the NMOS transistor 76. Meanwhile, upon receiving the setting signal Sig instructing the stop for the predetermined time period P0, the stop circuit 802 causes the driver circuit 90 to stop the switching of the NMOS transistor 76.

Further, as described above with reference to FIG. 5, the error amplifier circuit 210 included in the driver circuit 90 charges and discharges the capacitors 83, 84, based on the output voltage Vout1 and the reference voltage corresponding to the target level. A circuit included in the driver circuit 90 other than the error amplifier circuit 210 outputs the drive signal to switch the NMOS transistor 76, based on the voltage Ve and the inductor current IL. Note that the error amplifier circuit 210 corresponds to a "charge-discharge circuit", and the circuit included in the driver circuit 90 other than the error amplifier circuit 210 corresponds to a "drive signal output circuit".

### Operation of power factor correction IC 75f

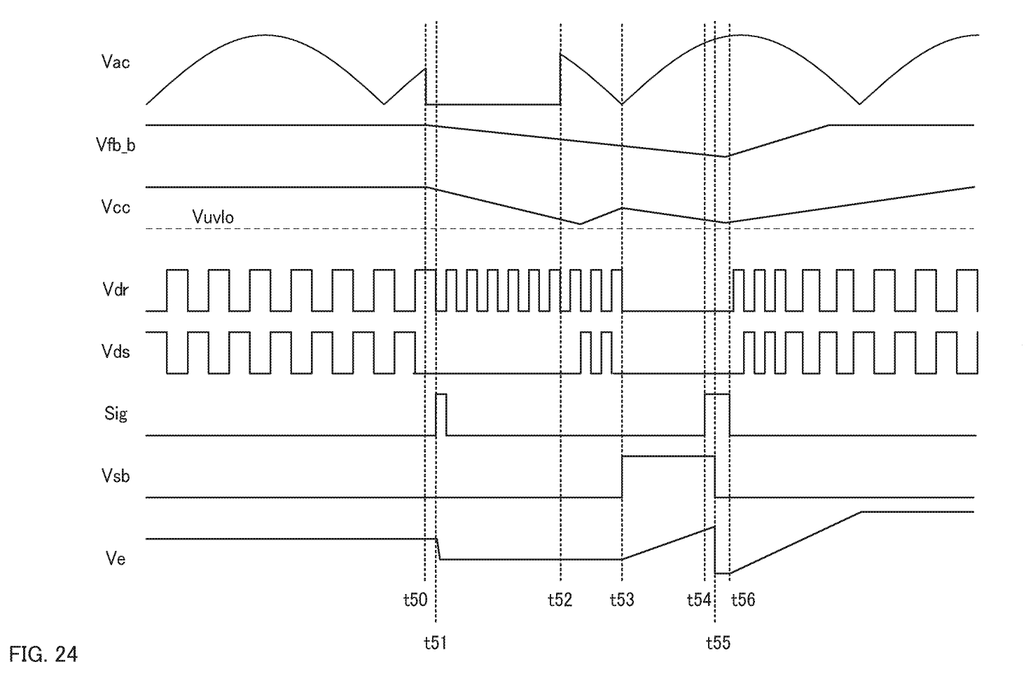

FIG. 24 is a diagram illustrating an example of an operation of the power factor correction IC 75f. At time t50, the AC voltage Vac stops. At time t51, at which the control IC 40a detects that the AC voltage Vac has stopped, the control IC 40a outputs the setting signal Sig instructing the stop. The stop circuit 802 then outputs the high signal en, and causes the operational amplifier 800 to lower the voltage Ve to the voltage level Vx.

Then, at time t52, at which the AC voltage Vac has been restored, the voltage Ve has been at the voltage level Vx, thereby suppressing the case where the NMOS transistor 76 is damaged even if the surge voltage occurs in the NMOS transistor 76. Further, the AC voltage Vac is restored and the NMOS transistor 76 is switched, and thus the power supply voltage Vcc rises.

Further, at time t53, at which the AC voltage Vac drops below the predetermined level V0, the stop circuit 802 outputs the high signal Vsb, and the driver circuit 90 stops the switching of the NMOS transistor 76. Then, because the switching of the NMOS transistor 76 is stopped, the power supply voltage Vcc and the output voltage Vout1 lowers, and the voltage Ve rises to raise the output voltage Vout1.

At time t54, the setting signal Sig instructing the restoration is inputted from the control IC 40a.

At time t55, at which the stop circuit 802 determines that the setting signal Sig is instructing the restoration, the stop circuit 802 outputs the high signal dchg. Thus, the NMOS transistor 801 discharges the capacitors 83, 84.

At time t56, at which the input of the setting signal Sig instructing the restoration is completed, the output voltage Vout1 has dropped, and thus the voltage Ve rises and the ON period of the NMOS transistor 76 also gradually becomes longer.

### Configuration of power factor correction IC 75g

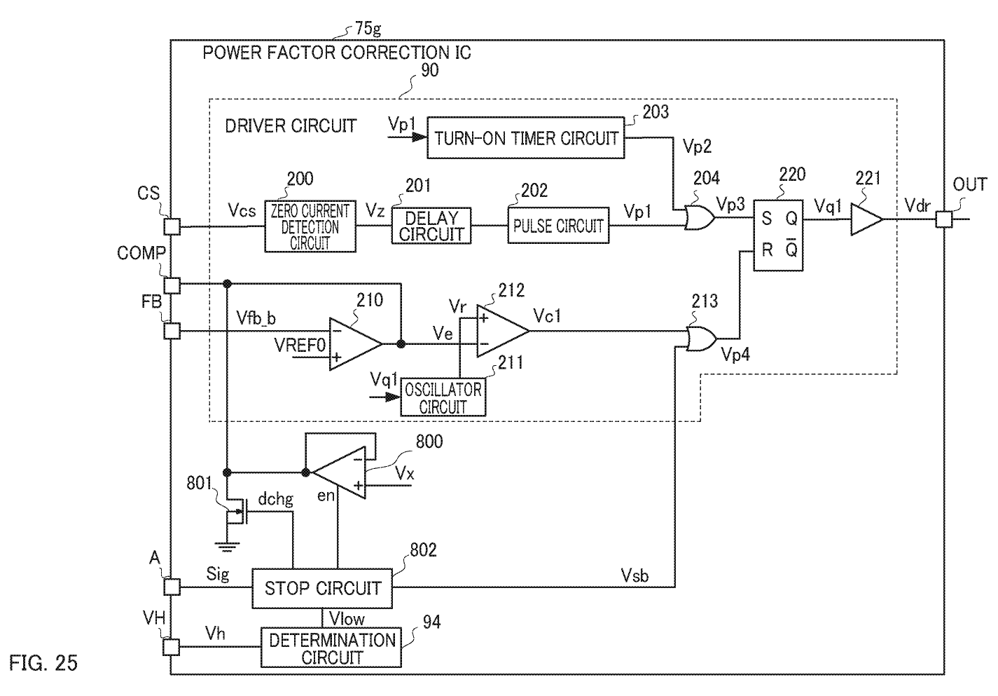

FIG. 25 is a diagram illustrating an example of a configuration of a power factor correction IC 75g, which is one embodiment of the power factor correction IC 75. The power factor correction IC 75g includes the driver circuit 90, the determination circuit 94, the operational amplifier 800, the NMOS transistor 801, and the stop circuit 802. Note that the operation of the power factor correction IC 75g is the same as the power factor correction IC 75f except that the power factor correction IC 75g detects the rectified voltage Vrec2 and operates accordingly, and thus an explanation thereof is omitted.

### SUMMARY

The power supply device 10 according to an embodiment of the present disclosure has been described above. The power factor correction IC 75b includes the terminal A, the determination circuit 92, the driver circuit 90, and the stop circuit 93. This makes it possible to provide an integrated circuit capable of controlling the operation of a power supply circuit in the event of an abnormality.

Further, the determination circuit 92 includes the estimation circuit 400 and the determination circuit 401. This makes it possible to determine the voltage level of the AC voltage Vac even if the terminal configured to receive the rectified voltage Vrec2 is not provided.

Further, the power factor correction IC 75d includes the terminal VH. This makes it possible to determine the voltage level of the AC voltage Vac, using the voltage Vh that is based on the rectified voltage Vrec2.

Further, the power factor correction IC 75f includes the operational amplifier 800. The operational amplifier 800 causes the driver circuit 90 to switch the NMOS transistor 76 such that the ON period thereof will be shorter than the predetermined time period, after the setting signal Sig instructing the stop is inputted, until the switching of the NMOS transistor 76 is stopped. This suppresses the case where the NMOS transistor 76 is damaged by the surge voltage, even if the AC voltage Vac is restored after an instantaneous power failure.

Further, the power factor correction IC 75f includes the terminals COMP and the NMOS transistor 801. The NMOS transistor 801 discharges the capacitors 83, 84 through the terminal COMP, in response to the setting signal Sig instructing the restoration being inputted. This makes it possible for the power factor correction IC 75f to gradually increase the ON period of the NMOS transistor 76 after the setting signal Sig instructing the restoration is inputted from the control IC 40a, thereby being able to perform so-called soft start.

Further, upon receiving the setting signal Sig instructing the stop for the predetermined time period P0, the stop circuit 93 causes the driver circuit 90 to stop the switching of the NMOS transistor 76. This makes it possible to control the operation of the AC-DC converter 12 even when the voltage level of the AC voltage Vac cannot be determined.

Further, the power supply device 10 includes the control IC 40c and the power factor correction IC 75d (or the power factor correction IC 75e). This makes it possible for the power factor correction IC 75d to cause the driver circuit 90 to stop the switching of the NMOS transistor 76, in response to the voltage level of the AC voltage Vac dropping below the predetermined level V0, after the setting signal Sig instructing the stop is inputted.

Further, the power supply device 10 includes the control IC 40b and the power factor correction IC 75a (or the power factor correction IC 75c). This makes it possible for the power factor correction IC 75a (or the power factor correction IC 75c) to control the operation of the AC-DC converter 12 without determining the voltage level of the AC voltage Vac.

The present disclosure is directed to provision of an integrated circuit capable of controlling the operation of the power supply circuit in the event of an abnormality.

According to the present disclosure, it is possible to provide an integrated circuit capable of controlling the operation of the power supply circuit in the event of an abnormality.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

What is claimed is:

1. An integrated circuit for a power supply circuit that generates an output voltage at a target level from an alternating current (AC) voltage inputted thereto, the power supply circuit including
an inductor configured to receive a voltage corresponding to the AC voltage, and
a transistor configured to control an inductor current flowing through the inductor,
the integrated circuit being configured to switch the transistor, the integrated circuit comprising:
a first terminal configured to receive a stop signal;
a first determination circuit configured to determine whether a voltage level of the AC voltage is lower than a predetermined level;
a driver circuit configured to switch the transistor, based on the inductor current and the output voltage; and
a stop circuit configured to cause the driver circuit to stop switching of the transistor, in response to the voltage level of the AC voltage dropping below the predetermined level after the stop signal is inputted.

2. The integrated circuit according to claim 1, wherein
the first determination circuit includes
an estimation circuit configured to estimate the voltage level of the AC voltage, based on the switching of the transistor, and
a second determination circuit configured to determine whether the voltage level of the AC voltage is lower than the predetermined level, based on an estimation result of the estimation circuit, wherein
the driver circuit
turns on the transistor, in response to the inductor current reaching a predetermined value, and
turns off the transistor, in response to a time period corresponding to the output voltage having elapsed.

3. The integrated circuit according to claim 1, further comprising:
a second terminal configured to receive a full-wave rectified voltage obtained by full-wave rectifying the AC voltage, wherein
the first determination circuit determines whether the voltage level of the AC voltage is lower than the predetermined level, based on the full-wave rectified voltage.

4. The integrated circuit according to claim 1, further comprising:
a control circuit configured to cause the driver circuit to switch the transistor such that an ON period of the transistor becomes shorter than a predetermined time period, after the stop signal is inputted, until the switching of the transistor is stopped.

5. The integrated circuit according to claim 4, further comprising:
a third terminal configured to be connected to a capacitor; and
a discharge circuit configured to discharge the capacitor, based on an output from the stop circuit, wherein
the driver circuit includes
a charge-discharge circuit configured to charge and discharge the capacitor, based on the output voltage and a reference voltage corresponding to the target level, and
a drive signal output circuit configured to output a drive signal to switch the transistor, based on a first voltage of the capacitor and the inductor current, and
the control circuit maintains a level of the first voltage such that the ON period of the transistor becomes shorter than the predetermined time period, based on the output from the stop circuit, and
the stop circuit causes the control circuit to maintain the level of the first voltage, in response to the stop signal being inputted to the first terminal, and causes the discharge circuit to operate, in response to a start signal being inputted to the first terminal.

6. The integrated circuit according to claim 1, wherein upon receiving the stop signal for a predetermined time period, the stop circuit causes the driver circuit to stop the switching of the transistor.

7. A power supply device, comprising:
a first power supply circuit that generates a first output voltage at a target level from an alternating current (AC) voltage inputted thereto, the first power supply circuit including
an inductor configured to receive a voltage corresponding to the AC voltage, and
a first transistor configured to control an inductor current flowing through the inductor;
a first integrated circuit configured to switch the first transistor;
a second power supply circuit that generates a second output voltage from the first output voltage; and
a second integrated circuit used for the second power supply circuit, the second integrated circuit including
a load detection circuit configured to detect a condition of a load configured to receive the second output voltage, and
a signal output circuit configured to output a stop signal when it is detected that the load has become an overload condition, wherein
the first integrated circuit includes:
a terminal configured to receive the stop signal,
a determination circuit configured to determine whether a voltage level of the AC voltage is lower than a predetermined level,
a driver circuit configured to switch the first transistor, based on the inductor current and the first output voltage, and
a stop circuit configured to cause the driver circuit to stop switching of the first transistor, in response to the voltage level of the AC voltage dropping below the predetermined level after the stop signal is inputted.

8. A power supply device, comprising:
a first power supply circuit that generates a first output voltage at a target level from an alternating current (AC) voltage inputted thereto, the first power supply circuit including
an inductor configured to receive a voltage corresponding to the AC voltage, and
a first transistor configured to control an inductor current flowing through the inductor;
a first integrated circuit configured to switch the first transistor;
a second power supply circuit that generates a second output voltage from the first output voltage; and
a second integrated circuit used for the second power supply circuit, the second integrated circuit including
a terminal configure to receive a full-wave rectified voltage obtained by full-wave rectifying the AC voltage,
a determination circuit configured to determine whether a voltage level of the AC voltage is lower than a predetermined level, based on the full-wave rectified voltage,
a load detection circuit configured to detect a condition of a load configured to receive the second output voltage, and
a signal output circuit configured to output a stop signal, in response to the determination circuit determining that the voltage level of the AC voltage drops below the predetermined level after it is detected that the load has become an overload condition, wherein
the first integrated circuit includes
a terminal thereof configured to receive the stop signal,
a driver circuit configured to switch the first transistor, based on the inductor current and the first output voltage, and
a stop circuit configured to cause the driver circuit to stop switching of the first transistor, upon receiving the stop signal.
